(19) United States
(12) Patent Application Publication
(10) Pub. No.: US 2022/0312069 A1
(43) Pub. Date: Sep. 29, 2022

(54) ONLINE VIDEO DISTRIBUTION SUPPORT METHOD AND ONLINE VIDEO DISTRIBUTION SUPPORT APPARATUS

(71) Applicant: PANASONIC INTELLECTUAL PROPERTY MANAGEMENT CO., LTD., Osaka (JP)

(72) Inventors: Takeshi YOSHIHARA, Fukuoka (JP); Koji HORIUCHI, Fukuoka (JP)

(73) Assignee: PANASONIC INTELLECTUAL PROPERTY MANAGEMENT CO., LTD., Osaka (JP)

(21) Appl. No.: 17/704,139

(22) Filed: Mar. 25, 2022

(30) Foreign Application Priority Data
Mar. 29, 2021 (JP) 2021-055471
Jan. 5, 2022 (JP) 2022-000698

(51) Int. Cl. H04N 21/442; H04N 21/2187; H04N 21/431; H04N 21/475

(52) U.S. Cl. CPC H04N 21/44213; H04N 21/2187; H04N 21/4312; H04N 21/4758

(57) ABSTRACT

An online video distribution support method is executed by a computer that is communicably connected to a plurality of viewer terminals respectively used by an N number of viewers (N is an integer equal to or larger than 2) who view an online video. The online video distribution support method includes acquiring viewer information during distribution of the online video; calculating an index indicating a viewing situation of the viewers during the distribution of the online video based on the acquired viewer information; and selecting an M number of viewers (M is an integer satisfying 1≤M<N) from the N number of viewers based on the calculated index and outputting information related to the selected M number of viewers.

### CROSS-REFERENCE TO RELATED APPLICATIONS

This application is based on and claims priority under 35 USC 119 from Japanese Patent Application No. 2021-055471 filed on Mar. 29, 2021 and Japanese Patent Application No. 2022-000698 filed on Jan. 5, 2022, the contents of which are incorporated herein by reference.

### TECHNICAL FIELD

The present disclosure relates to an online video distribution support method and an online video distribution support apparatus.

### BACKGROUND ART

JP-A-2019-086549 discloses a web learning apparatus that is connected to an information terminal of a participant via a communication circuit and changes a moving image to be extracted next according to a determined understanding level of the participant. The web learning apparatus stores a moving image including a lecture video and an exercise in a moving image storage unit, and distributes a moving image extracted from the moving image storage unit to the information terminal. The web learning apparatus distributes an exercise to the information terminal after distributing a lecture video, receives an answer to the exercise transmitted from the information terminal, and determines an understanding level of a participant with respect to a moving image based on contents or correctness of the received answer to the exercise. Here, a distributor who uses an online video distribution service by using a moving image or a live video stored in advance may select any viewer during an online video distribution and ask the viewer a question or answer a question from the viewer. In such a case, there is a demand for the distributor to adaptively select a viewer according to question contents, distribution contents, and the like, but it is difficult to know states of all viewers (for example, an interest level, an understanding level, or the like with respect to the distribution contents). In addition, it is not possible to determine an understanding level of a participant (viewer) during a lecture video distribution (that is, during an online video distribution) in the web learning apparatus.

### SUMMARY OF INVENTION

The present disclosure is made in view of the circumstances in the related art described above, and an object of the present disclosure is to provide an online video distribution support method and an online video distribution support apparatus that efficiently calculate a state of a viewer who views a live video online and efficiently support a distributor to select a questioner.

Aspect of non-limiting embodiments of the present disclosure relates to provide an online video distribution support method executed by an online video distribution support system including one or more computers that are communicably connected to a plurality of viewer terminals respectively used by an N number of viewers (N is an integer equal to or larger than 2) who view an online video. The online video distribution support method includes: acquiring viewer information related to the viewers during distribution of the online video; calculating an index indicating a viewing situation of the viewers during the distribution of the online video based on the acquired viewer information; and selecting an M number of viewers (M is an integer satisfying 1≤M<N) from the N number of viewers based on the calculated index and outputting information related to the selected M number of viewers and outputting information related to the selected M number of viewers.

Another aspect of non-limiting embodiments of the present disclosure relates to provide an online video distribution support apparatus including one or more computers. The online video distribution support apparatus includes: an acquisition unit configured to acquire viewer information related to an N number of viewers (N is an integer equal to or larger than 2) who view an online video; a calculation unit configured to calculate an index indicating a viewing situation of the viewers during distribution of the online video based on the viewer information; and an output unit configured to select an M number of viewers (M is an integer satisfying 1≤M<N) from the N number of viewers based on the index calculated by the calculation unit and configured to output information related to the selected M number of viewers.

According to the present disclosure, it is possible to efficiently calculate a state of a viewer who views a live video online and efficiently support a distributor to select a questioner.

### BRIEF DESCRIPTION OF DRAWINGS

FIG. 1 is a block diagram showing an example of an internal configuration of a distributor terminal and a server in an online video distribution support system according to a first embodiment.

FIG. 2 is a block diagram showing an example of an internal configuration of a viewer terminal in the online video distribution support system according to the first embodiment.

FIG. 3 is a view showing a use case example of the distributor terminal and an example of a video distribution screen.

FIG. 4 is a view showing a use case example of the viewer terminal and an example of a video distribution screen.

FIG. 5 is a sequence diagram showing an example of an operation procedure in a default mode of the online video distribution support system according to the first embodiment.

FIG. 6 is a sequence diagram showing an example of a mode change procedure of the online video distribution support system according to the first embodiment.

FIG. 7 is a sequence diagram showing an example of an operation procedure in a lecture mode of the online video distribution support system according to the first embodiment.

FIG. 8 is a sequence diagram showing an example of a setting procedure of a grouping method in the online video distribution support system according to the first embodiment.

FIG. 9 is a sequence diagram showing an example of a grouping procedure of the online video distribution support system according to the first embodiment.

FIG. 10 is a sequence diagram showing an example of a grouping procedure of the online video distribution support system according to the first embodiment.

FIG. 11 is a sequence diagram showing an example of an operation procedure in a question mode of the online video distribution support system according to the first embodiment.

FIG. 12 is a diagram showing an example of an index value table.

FIG. 13 is a view showing an example of a question mode screen displayed on a distributor terminal.

FIG. 14 is a view showing an example of a question mode screen displayed on a distributor terminal.

FIG. 15 is a view showing an example of a question mode screen displayed on a viewer terminal.

FIG. 16 is a view showing an example of a question mode screen displayed on a viewer terminal.

FIG. 17 is a view showing an example of a question mode screen displayed on a distributor terminal and a viewer terminal.

FIG. 18 is a view showing an example of a question mode screen displayed on a distributor terminal and a viewer terminal.

FIG. 19 is a view showing an example of a preview screen.

FIG. 20 is a view showing an example of a preview screen.

FIG. 21 is a block diagram showing an example of an internal configuration of an online video distribution support system according to a second embodiment.

### DESCRIPTION OF EMBODIMENTS

Hereinafter, embodiments specifically disclosing configurations and operations of an online video distribution support method and an online video distribution support apparatus according to the present disclosure will be described in detail with reference to the drawings as appropriate. Unnecessarily detailed description may be omitted. For example, detailed description of a well-known matter or repeated description of substantially the same configuration may be omitted. This is to avoid unnecessary redundancy in the following description and to facilitate understanding of those skilled in the art. The accompanying drawings and the following description are provided for those skilled in the art to fully understand the present disclosure, and are not intended to limit the subject matter described in the claims.

### First Embodiment

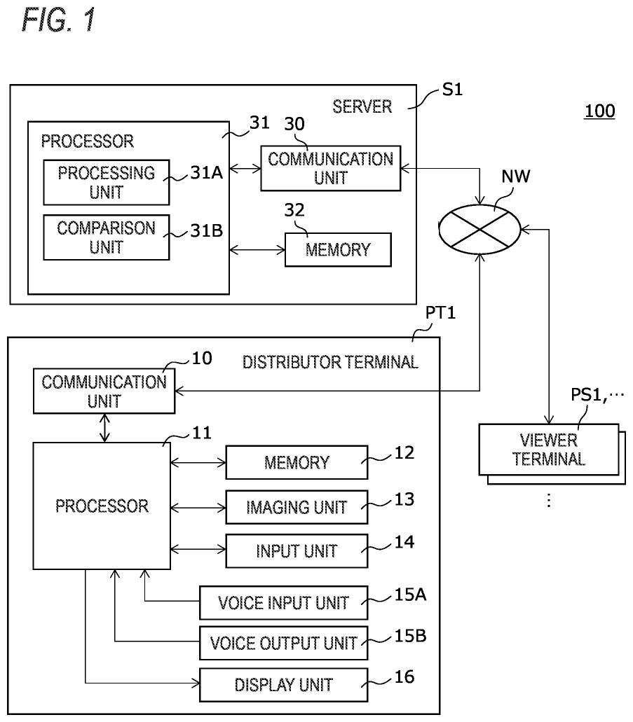

First, an internal configuration of an online video distribution support system 100 according to a first embodiment will be described with reference to FIG. 1. FIG. 1 is a block diagram showing an example of an internal configuration of the online video distribution support system 100 according to the first embodiment. The online video distribution support system 100 shown in FIG. 1 is an example, and the present invention is not limited thereto.

A distributor terminal PT1 is operated by a distributor TC who distributes a video during an online video distribution, and is implemented by, for example, a personal computer (PC), a notebook PC, a tablet terminal, a smartphone, or the like. The distributor terminal PT1 is connected, via a network NW, to a server S1 and viewer terminals PS1 that are used by one or more viewers who view an online video distribution so that the distributor terminal PT1 can execute wireless communication with the server S1, and the viewer terminals PS1. Here, the wireless communication is communication executed via a wireless local area network (LAN) such as Wi-Fi (registered trademark).

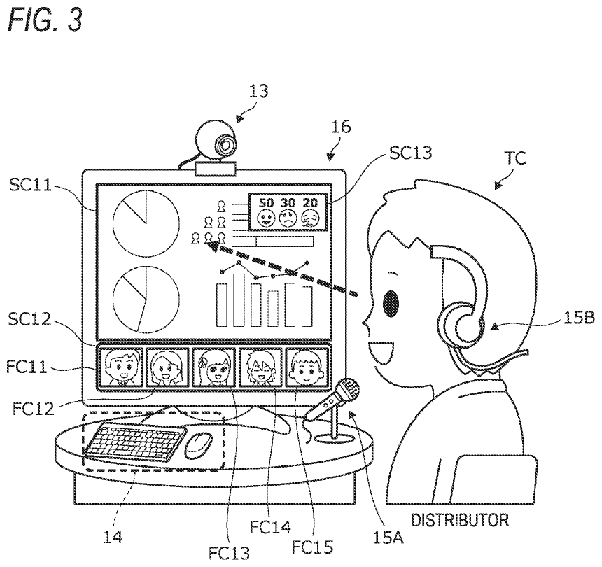

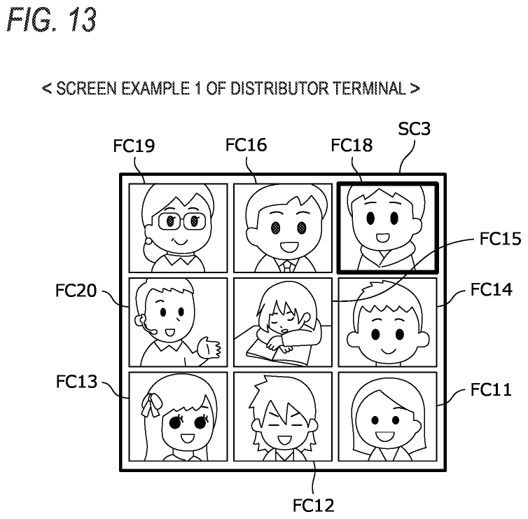

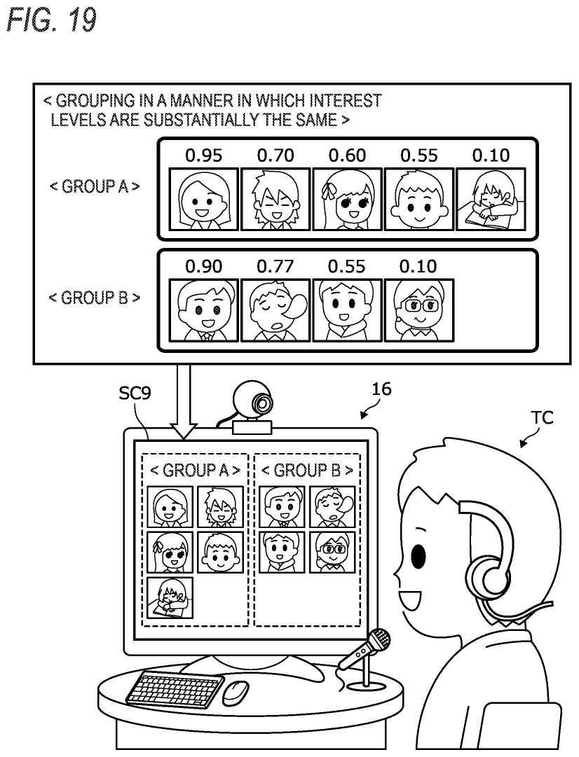

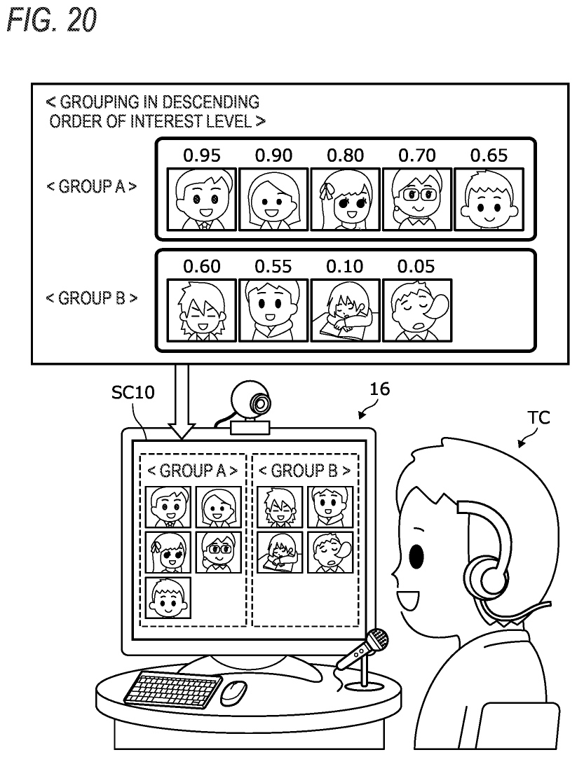

The distributor terminal PT1 receives a setting operation for various kinds of setting (for example, setting related to a grouping method, setting related to a method of selecting a questioner, setting related to an index value, and the like) set by the distributor TC, and transmits the set various kinds of setting information to the server S1. The distributor terminal PT1 displays a video distribution screen SC1 (see FIG. 3) transmitted from the server S1 on a display unit 16. The distributor terminal PT1 displays, on the display unit 16, various screens (for example, the video distribution screen SC1 (see FIG. 3), question mode screens SC3, SC4, SC7, and SC8 (see FIGS. 13, 14, 17, and 18), and preview screens SC9 and SC10 (see FIGS. 19 and 20)) generated and transmitted by the server S1 based on various kinds of setting information.

The distributor terminal PT1 extracts or calculates and acquires biological information (for example, pulse, heartbeat, respiration, a position of the line of sight of the distributor TC, or the like) of the distributor TC based on a captured image of the distributor TC (hereinafter, referred to as a “distributor image”) captured by an imaging unit 13. Here, the position of the line of sight indicates a position (coordinates) at which the line of sight of the distributor TC is directed on a video distribution screen (for example, the video distribution screen SC1 shown in FIG. 3) displayed on the display unit 16. The distributor terminal PT1 transmits the acquired biological information, voice data, and the like of the distributor TC to the server S1.

The distributor terminal PT1 includes a communication unit 10, a processor 11, a memory 12, the imaging unit 13, an input unit 14, a voice input unit 15A, a voice output unit 15B, and the display unit 16. Although not shown in FIG. 1, the distributor terminal PT1 may include two or more display units.

The communication unit 10 transmits data to and receives data from the server S1 and each of a plurality of viewer terminals PS1 via the network NW. The communication unit 10 outputs various screens transmitted from the server S1 to the processor 11. The communication unit 10 transmits, to the server S1, the biological information of the distributor TC, various kinds of setting information, various control commands, and the like output from the processor 11, and transmits data of a shared material designated by the distributor TC to the server S1.

Here, the shared material will be described. The shared material is data shared with the distributor terminal PT1 and the viewer terminals PS1 . . . , and displayed on the display unit 16 of the distributor terminal PT1 and the display units 26 of the viewer terminals PS1 respectively to be viewable by the distributor TC and the viewers respectively. For example, the shared material is a slide material including a plurality of pieces of image data for presentation, a material in a portable document format (PDF), live video (moving image) data, recorded video (moving image) data, image data, or the like. The shared material may be data transmitted from a viewer terminal of any viewer permitted or designated by the distributor TC.

The processor 11 is configured with, for example, a central processing unit (CPU) or a field programmable gate array (FPGA), and executes various processings and controls in cooperation with the memory 12. Specifically, the processor 11 refers to a program and data stored in the memory 12, and executes the program to implement functions of units. For example, the processor 11 executes a function of extracting biological information of the distributor TC from a distributor image, a function of calculating a position of the line of sight of the distributor TC from the distributor image, and the like.

The processor 11 executes a convolutional neural network (CNN) analysis processing on a distributor image output from the imaging unit 13, and calculates a position of the line of sight of the distributor TC. The processor 11 outputs, to the communication unit 10, the calculated position information of the line of sight of the distributor TC, imaging time of the distributor image used for calculating the position of the line of sight, and identification information capable of identifying the distributor TC (for example, a name of the distributor TC, an account name of the distributor TC, an Internet Protocol (IP) address of the distributor terminal PT1, a mail address, and the like) in association with one another, and causes the communication unit 10 to transmit these kinds of information to the server S1.

The processor 11 extracts the biological information of the distributor TC based on the distributor image output from the imaging unit 13. The processor 11 outputs, to the communication unit 10, the extracted biological information of the distributor TC, the imaging time of the distributor image used for extracting the biological information, and the identification information capable of identifying the distributor TC (for example, a name, an account name, an identification (ID) of the distributor TC, an IP address of the distributor terminal PT1, a mail address, and the like) in association with one another, and causes the communication unit 10 to transmit the these kinds of information to the server S1.

The memory 12 includes a recording device including a semiconductor memory such as a random access memory (RAM) and a read only memory (ROM) and a storage device such as a solid state drive (SSD) and a hard disk drive (HDD). The memory 12 stores a learning model and the like used for the CNN analysis processing.

The imaging unit 13 is, for example, a solid-state imaging element such as a charged-coupled device (CCD) or a complementary metal oxide semiconductor (CMOS), and converts an optical image formed on an imaging surface into an electric signal. The imaging unit 13 outputs a distributor image obtained by imaging the distributor TC to the processor 11.

The input unit 14 is a user interface configured with, for example, a touch panel, a keyboard, a mouse, or the like. The input unit 14 converts a received operation of the distributor TC into an electric signal (a control command) and outputs the electric signal to the processor 11. When the input unit 14 is configured with a touch panel, the input unit 14 may be configured integrally with the display unit 16.

The voice input unit 15A includes a microphone or the like, converts collected voice (sound) of the distributor TC into an electric signal, and outputs the electric signal to the processor 11. The electrical signal output to the processor 11 is transmitted from the communication unit 10 to each of the viewer terminals PS1 via the server S1 and the network NW or is transmitted from the communication unit 10 directly to each of the viewer terminals PS1, and is output from a speaker (not shown) provided in each of the viewer terminals PS1.

The voice output unit 15B includes, for example, a speaker, an earphone, a headphone, and the like, and converts a voice signal (an electric signal) of a viewer transmitted from each of the plurality of viewer terminals PS1 or the server S1 into voice or sound and outputs the voice or sound.

The display unit 16 is configured with, for example, a display such as a liquid crystal display (LCD) or an organic electroluminescence (EL). The display unit 16 displays the video distribution screen SC1 (see FIG. 3) and various screens output from the processor 11.

Although an example will be described in the following description in which a shared material that is image data is included and displayed on the video distribution screen SC1 of the distributor terminal PT1 and each of the plurality of viewer terminals PS1 in order to make the description easy to understand, the data included and displayed on the video distribution screen SC1 is not limited to the image data. For example, the data included and displayed on the video distribution screen SC1 may be video data imaged by the distributor TC. In such a case, each of the plurality of viewer terminals PS1 displays video data distributed in real time from the distributor terminal PT1 on a video distribution screen SC2.

The server S1 serving as an example of an online video distribution support apparatus is connected to the distributor terminal PT1 and each of the plurality of viewer terminals PS1 via the network NW so that the server S1 can execute wireless communication with the distributor terminal PT1, and each of the plurality of viewer terminals PS1. Here, the wireless communication is, for example, communication executed via a wireless LAN such as Wi-Fi (registered trademark).

The server S1 extracts biological information of the distributor TC and biological information of each of a plurality of viewers, and records the extracted biological information for each person (the distributor TC and each of the plurality of viewers). The server S1 calculates (evaluates) various parameters such as an interest level, an understanding level, and a sympathy level for each person based on the recorded biological information. The server S1 calculates an index value based on calculation (evaluation) results of various parameters and various kinds of setting information (setting information related to a grouping method and setting information related to selection of a questioner candidate). Here, the questioner is a viewer who makes a call with (for example, asks a question to) the distributor TC among the plurality of viewers. The index value is a value serving as an index for grouping viewers or selecting a questioner. Based on the calculated various parameters or index values, the server S1 groups a plurality of viewers who view an online video distribution into a plurality of groups, selects one or more questioner candidates, and generates a question mode screen including a face image of the selected questioner candidate (that is, a face image of a viewer). The server S1 includes a communication unit 30, a processor 31, and a memory 32.

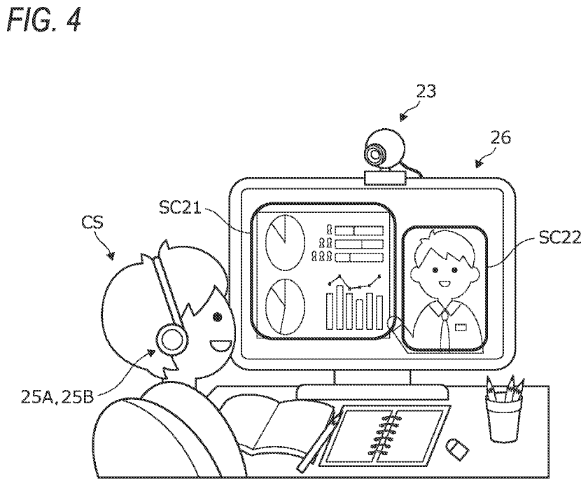

The communication unit 30 serving as an example of an acquisition unit transmits data to and receives data from the distributor terminal PT1 and each of the plurality of viewer terminals PS1 via the network NW. The communication unit 30 outputs, to the processor 31, various control commands, various kinds of setting information, data of a shared material, a distributor image, a viewer image, biological information of the distributor TC or a viewer, and the like that are transmitted from the distributor terminal PT1. In addition, the communication unit 30 transmits various screens (for example, a video distribution screen (see FIGS. 3 and 4), a question mode screen (see FIGS. 13 to 18), and preview screens SC9 and SC10 (see FIGS. 19 and 20)) output from the processor 31 to a corresponding terminal device (the distributor terminal PT1 or a viewer terminal). The viewer image referred to here is a captured image of a viewer captured by a viewer terminal.

The processor 31 is configured with, for example, a CPU or an FPGA, and executes various processings and controls in cooperation with the memory 32. Specifically, the processor 31 implements functions of units by referring to a program and data stored in the memory 32 and executing the program. The units referred to here are the processing unit 31A and the comparison unit 31B. For example, the processor 31 executes a function of executing an index value, a function of grouping viewers, a function of selecting a questioner, a function of generating various screens, and the like based on the biological information of the distributor TC transmitted from the distributor terminal PT1 and the biological information of a viewer transmitted from each of the viewer terminals PS1.

The processor 31 changes various modes during an online video distribution based on the control command transmitted from the distributor terminal PT1. The various modes referred to here include, for example, a lecture mode, a group discussion mode, a question mode, a default mode, and the like.

The lecture mode is a mode in which the distributor terminal PT1 and each of the plurality of viewer terminals PS1 can access the same venue (hereinafter referred to as a “main venue”), and each of the plurality of viewer terminals PS1 can view a shared material, listen to the voice of the distributor TC, and the like. The shared material, the voice of the distributor TC, and the like are transmitted (distributed) from the distributor terminal PT1. The processor 31 in the lecture mode executes controls (for example, switching of data, slides, pages, and the like of the shared material) based on various control commands transmitted from the distributor terminal PT1, acquires biological information of the distributor TC and each of the plurality of viewers, calculates (evaluates) various parameters and index values based on the acquired biological information, and stores the parameters and index values in the memory 32 for each viewer.

The group discussion mode is a mode in which a plurality of viewers are grouped into two or more groups, an online video distribution venue in which only viewers grouped in each group can participate (hereinafter referred to as a “sub venue”) is created, and the viewers are moved to (access) a corresponding sub venue, thereby enabling group discussion, group work, and the like among viewers grouped in each group.

The question mode is a mode in which one or more questioner candidates are selected from a plurality of viewers based on a questioner candidate selection method set in advance by the distributor TC, a question mode screen including an image of the selected questioner candidate (that is, a viewer image of the viewer) is generated, and a call (conversation) between the distributor TC and the questioner (viewer) named (selected) by the distributor TC can be made.

The default mode is a mode executed at the timing when the online video distribution is started. Any one of the lecture mode, the group discussion mode, and the question mode described above may be set as the default mode in advance by the distributor TC.

For example, in a case where the distributor TC wants to speak with (that is, ask a question to) any viewer immediately after the distributor TC starts an online video distribution, the default mode may be set to the question mode. Similarly, in a case where the distributor TC wants to group a plurality of viewers into two or more groups and perform group discussion, group work, or the like immediately after the distributor TC starts an online video distribution, the group discussion mode may be set as the default mode.

The processing unit 31A in the lecture mode, serving as an example of an output unit, records the biological information of the distributor TC transmitted from the distributor terminal PT1, the imaging time information of a distributor image used to acquire the biological information, and the identification information of the distributor TC in the memory 32 in association with one another. Similarly, the biological information of a viewer transmitted from each of the plurality of viewer terminals PS1, the imaging time information of a viewer image used to acquire the biological information, and identification information of a viewer are recorded in the memory 32 in association with one another.

The processing unit 31A refers to the biological information of the distributor TC and the biological information of each of the plurality of viewers recorded during a target period based on information of the target period included in setting information related to a grouping method. The processing unit 31A generates various kinds of data used for calculating (evaluating) various parameters of the distributor TC and each of the viewers.

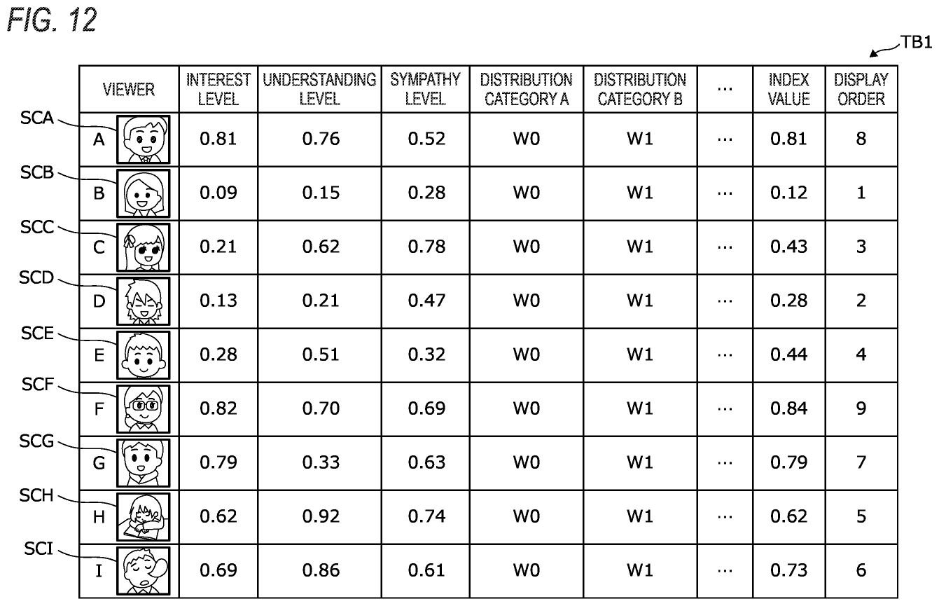

The processing unit 31A in the lecture mode generates the video distribution screen SC1 (see FIG. 3) including viewer images of a predetermined number of viewers (for example, five persons, eight persons, ten persons, or the like) from the top of a display order based on the display order of a plurality of viewers recorded in an index value table TB1 (see FIG. 12), and transmits the video distribution screen SC1 to the distributor terminal PT1. The distributor terminal PT1 outputs the video distribution screen SC1 transmitted from the server S1 to the display unit 16 and displays the video distribution screen SC1.

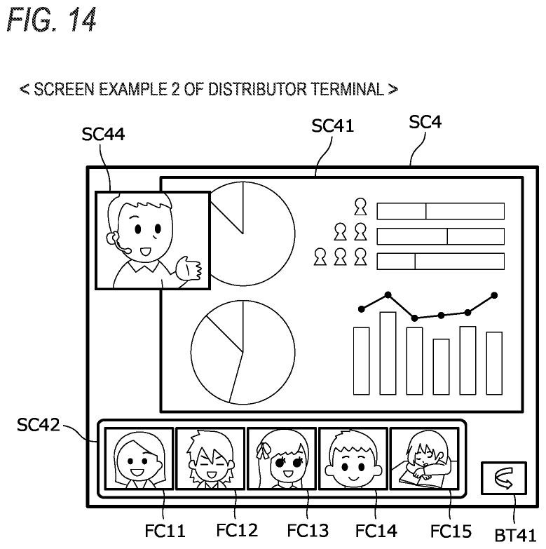

The processing unit 31A in the question mode generates the question mode screens SC3 and SC4 (see FIGS. 13 and 14) including viewer images of a predetermined number of (for example, five, eight, or ten) viewers (that is, questioner candidates) from the top of a display order based on the display order of a plurality of viewers recorded in the index value table TB1 (see FIG. 12) and setting information related to a questioner candidate selection method, and transmits the question mode screens SC3 and SC4 to the distributor terminal PT1. The distributor terminal PT1 outputs the question mode screens SC3 and SC4 transmitted from the server S1 to the display unit 16 and displays the question mode screens SC3 and SC4.

A method of determining a display order may be set by the distributor TC. For example, when a method of determining a plurality of viewer images displayed in a viewer image display region SC12 is a method of setting interest levels of viewers in descending order, the comparison unit 31B determines a display order in which the interest levels of the viewers recorded in the index value table are in descending order, and when a method of determining a plurality of viewer images is a method of setting index values of viewers in ascending order, the comparison unit 31B determines a display order in which the index values of the viewers recorded in the index value table are in ascending order. As described above, the index value for determining a display order of a plurality of viewer images displayed in the viewer image display region SC12 is not limited to the index value described above, and any parameter may be simply used as the index value, or a value calculated using two or more parameters may be used as the index value.

The viewer image display region is a region in which viewer images are displayed on various screens (a video distribution screen, a question mode screen, and the like). The viewer images displayed in the viewer image display region may be different between various screens displayed on the distributor TC and various screens displayed on the plurality of viewer terminals PS1.

The comparison unit 31B in a lecture mode, serving as an example of a calculation unit, calculates (evaluates) various parameters such as an interest level, an understanding level, and a sympathy level of each viewer based on the biological information of the distributor TC and the biological information of each of the plurality of viewers stored in the memory 32 by the processing unit 31A or various kinds of data generated by the processing unit 31A based on a control command transmitted from the distributor terminal PT1. The comparison unit 31B calculates (evaluates) an index value for each viewer based on a calculation (evaluation) result of various parameters and various kinds of setting information (setting information related to a grouping method and setting information related to the selection of a questioner candidate), and records the index value in the index value table TB1 (see FIG. 12) of the memory 32. The comparison unit 31B may calculate (evaluate) a first index value used in the group discussion mode and a second index value used in the question mode, and record the first index value and the second index value in the index value table TB1 (see FIG. 12) in the memory 32. Further, the comparison unit 31B determines a display order of face images (viewer images) of questioner candidates displayed on a question mode screen based on setting information related to the questioner candidate selection method, and records the determined display order in the index value table TB1 (see FIG. 12) of the memory 32.

The processing unit 31A in the group discussion mode groups a plurality of viewers into two or more groups based on the setting information related to a grouping method and the various parameters or index values of the distributor TC and the viewers calculated (evaluated) by the comparison unit 31B during the lecture mode and. The processing unit 31A generates an address for moving to a sub venue in which only viewers grouped into each group can participate, and transmits address information of the sub venue for a group corresponding to each of the plurality of viewer terminals PS1. The processing unit 31A generates, for each group, a video distribution screen (not shown) shared and displayed by the viewer terminals that were moved to (accessed) each sub venue, and transmits the video distribution screen to a viewer terminal corresponding to each group.

The processing unit 31A in the question mode rearranges a plurality of viewers based on a display order of the distributor TC and the viewers calculated (evaluated) by the comparison unit 31B during the lecture mode, and selects a questioner candidate to be displayed on the question mode screen. The processing unit 31A generates a question mode screen including face images (viewer images) of one or more selected questioner candidates, and transmits the question mode screen to the distributor terminal PT1 and each of the plurality of viewer terminals PS1 to display the question mode screen. The questioner candidates (that is, the viewer images of the viewers) displayed on the question mode screen displayed by the distributor terminal PT1 may be different from the viewer images of the viewers displayed on the question mode screen displayed by each of the plurality of viewer terminals PS1.

The comparison unit 31B generates the video distribution screen SC1 including viewer bird's eye view information (see FIG. 3) indicating a distribution of interest levels of a plurality of viewers with respect to a shared material based on the calculated (evaluated) interest levels, and transmits the video distribution screen SC1 to the distributor terminal PT1. The distributor terminal PT1 outputs the video distribution screen SC1 transmitted from the server S1 to the display unit 16 and displays the video distribution screen SC1. Although the viewer bird's eye view information has been described as an example indicating the distribution of the interest levels, the viewer bird's eye view information may be a distribution of understanding levels or sympathy levels.

The memory 32 serving as an example of a storage unit includes a recording device provided with a semiconductor memory such as a RAM and a ROM and a storage device such as an SSD and an HDD. The memory 32 stores identification information of the distributor TC, identification information of each of a plurality of viewers, the index value table TB1 (see FIG. 12), and the like. The memory 32 may record an index value table used in the group discussion mode and an index value table used in the question mode as separate tables.

The network NW connects the distributor terminal PT1 and each of the plurality of viewer terminals PS1 so that the distributor terminal PT1 and each of the plurality of viewer terminals PS1 can perform wired communication or wireless communication.

Each of the plurality of viewer terminals PS1 is operated by a viewer who views an online video distribution, and is implemented by, for example, a PC, a notebook PC, a tablet terminal, a smartphone, or the like. Each of the plurality of viewer terminals PS1 is connected to the server S1 and the distributor terminal PT1 via the network NW so that each of the plurality of viewer terminals PS1 can execute wireless communicate with the server S1 and the distributor terminal PT1. Here, the wireless communication is communication executed via a wireless LAN such as Wi-Fi (registered trademark).

Each of the plurality of viewer terminals PS1 includes the imaging unit 23 that can capture an image of a viewer, and extracts biological information of the viewer from the captured viewer image (live video), calculate a position of the line of sight of the viewer, and the like. Each of the plurality of viewer terminals PS1 transmits the extracted biological information of the viewer, the calculated position of the line of sight of the viewer, and identification information of the viewer to the server S1 in association with one another. Each of the plurality of viewer terminals PS1 displays the video distribution screen SC2 including a shared material, a distributor image, and the like transmitted from the server S1, or various screens, and converts an electric signal into voice (sound) and outputs the voice from a speaker (not shown).

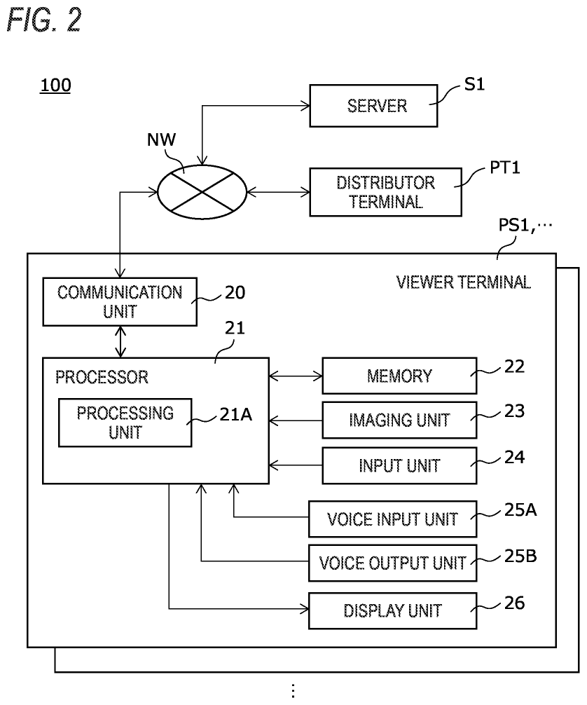

Next, an example of an internal configuration of each of the plurality of viewer terminals PS1 will be described with reference to FIG. 2. FIG. 2 is a block diagram showing an example of an internal configuration of each of the viewer terminals PS1 in the online video distribution support system 100 according to the first embodiment. The viewer terminal PS1 shown in FIG. 2 is an example, and the present invention is not limited thereto. Since the plurality of viewer terminals PS1 have the same configuration, an example of an internal configuration of one viewer terminal PS1 will be described here.

The viewer terminal PS1 includes a communication unit 20, a processor 21, a memory 22, the imaging unit 23, an input unit 24, a voice input unit 25A, a voice output unit 25B, and the display unit 26.

The communication unit 20 transmits data to and receives data from the server S1 and the distributor terminal PT1 via the network NW. The communication unit 20 outputs, to the processor 21, a video distribution screen, various screens, address information used for moving to a sub venue, and the like that are transmitted from the server S1. The communication unit 20 transmits, to the server S1, an image of a viewer, biological information of the viewer, the position of the line of sight of the viewer (that is, the position at which the line of sight of the viewer is directed on the video distribution screen SC2 (see FIG. 4) displayed on the display unit 26), identification information of the viewer, an answer to understanding level check data, and the like that are output from the processor 21.

The understanding level check data is, for example, a test, a questionnaire, or the like, and is data used for checking an understanding level related to distribution contents of an online video distribution. The understanding level check data may be a shared material.

The processor 21 is configured with, for example, a CPU or an FPGA, and executes various processings and controls in cooperation with the memory 22. Specifically, the processor 21 refers to a program and data stored in the memory 22, and executes the program to implement functions of units. For example, the processor 21 executes a function of extracting the biological information of the viewer from the viewer image by a processing unit 21A, a function of calculating the position of the line of sight of the viewer from the viewer image, and the like.

The processing unit 21A executes a CNN analysis processing on the viewer image output from the imaging unit 23, calculates the position of the line of sight of the viewer, and extracts biological information (pulse, heartbeat, respiration, and the like) of the viewer. The position of the line of sight and the biological information of the viewer may be detected by different processings. For example, the processing unit 21A may detect the position of the line of sight by executing the CNN analysis processing on the viewer image output from the imaging unit 23, and may detect the biological information of the viewer by executing a filter processing or a noise removal processing on the viewer image output from the imaging unit 23. A known technique other than the CNN analysis processing may be used for a processing of estimating the position of the line of sight. The processing unit 21A acquires various kinds of input information of viewers output from the input unit 24. The processing unit 21A outputs position information of the line of sight of the viewer serving as a calculation result, imaging time of the viewer image used for calculating the position of the line of sight or used for extracting the biological information, identification information capable of identifying a viewer (for example, a name, an account name, and an ID of a viewer, and an IP address of the viewer terminal PS1, a mail address, and the like), and various kinds of input information to the communication unit 20 in association with one another, and causes the communication unit 20 to transmit these kinds of information to the server S1.

The memory 22 includes a recording device provided with a semiconductor memory such as a RAM and a ROM and a storage device such as an SSD and an HDD. The memory 22 stores a learning model used for the CNN analysis processing, identification information of a viewer, and the like.

The imaging unit 23 is, for example, a solid-state imaging device such as a CCD or a CMOS, and converts an optical image formed on an imaging surface into an electric signal. The imaging unit 23 outputs a viewer image obtained by capturing an image of a viewer to the processor 21.

The input unit 24 is a user interface configured with, for example, a touch panel, a keyboard, a mouse, or the like. The input unit 24 converts a received viewer operation into an electric signal (a control command) and outputs the electric signal to the processor 21. When the input unit 24 is configured with a touch panel, the input unit 24 may be configured integrally with the display unit 26.

The voice input unit 25A includes a microphone or the like, converts collected voice (sound) of a viewer into an electric signal, and outputs the electric signal to the processor 21.

The electrical signal output to the processor 21 is transmitted from the communication unit 20 to the server S1 or the distributor terminal PT1 via the network NW.

The voice output unit 25B includes, for example, a speaker, an earphone, a headphone, and the like, and converts an electrical signal based on voice (sound) of a distributor transmitted from the distributor terminal PT1 into voice (sound) and outputs the voice (sound).

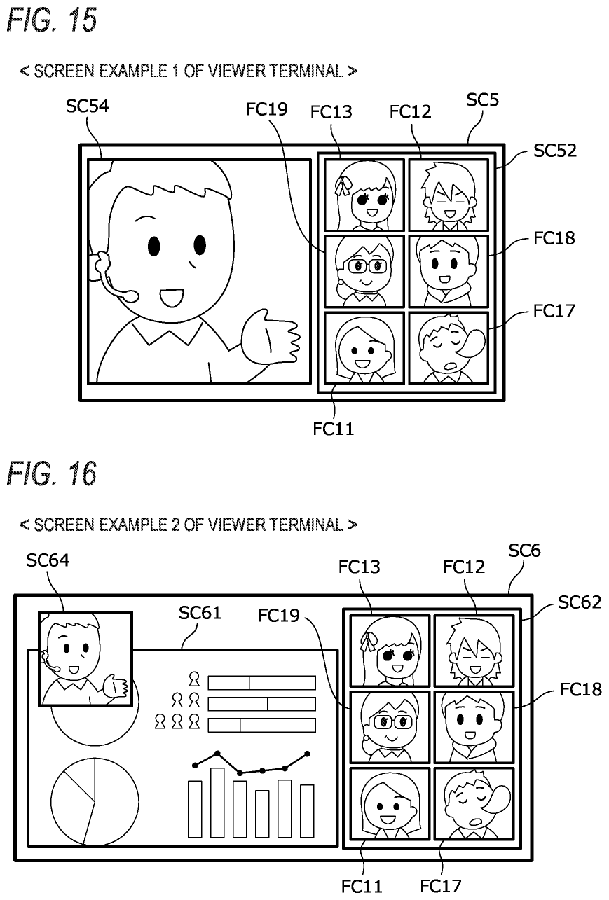

The display unit 26 is configured with, for example, a display such as an LCD or an organic EL. The display unit 26 displays the video distribution screen SC2 (see FIG. 4), question mode screens SC5, SC6, SC7, and SC8 (see FIGS. 15 to 18), and the like output from the processor 21.

Next, the video distribution screen SC1 displayed on the display unit 16 of the distributor terminal PT1 will be described with reference to FIG. 3. FIG. 3 is a view showing a use case example of the distributor terminal PT1 and an example of the video distribution screen SC1. A display layout of the video distribution screen SC1 shown in FIG. 3 is an example, and the present invention is not limited thereto.

The imaging unit 13 shown in the use case example in FIG. 3 is installed at a position where the imaging unit 13 can image the face of the distributor TC. It is needless to say that the installation position of the imaging unit 13 is not limited to a position on the display unit 16 as long as the imaging unit 13 can image the face of the distributor TC.

The input unit 14 shown in the use case example in FIG. 3 is implemented by a keyboard and a mouse. The voice input unit 15A is implemented by a microphone. The voice output unit 15B is implemented by a headphone. When the voice output unit 15B is implemented by, for example, a headphone with a microphone, the voice input unit 15A may be configured integrally with the voice output unit 15B.

The display unit 16 shown in the use case example in FIG. 3 displays the video distribution screen SC1 including a shared material display region SC11, a viewer image display region SC12, and an interest level distribution information display region SC13. A shared material for an online video distribution designated by an operation of the distributor TC is displayed in the shared material display region SC11.

Viewer images (live videos) FC11, FC12, FC13, FC14, and FC15 of five viewers determined by the comparison unit 31B in the processor 31 are displayed in the viewer image display region SC12. The viewer images displayed in the viewer image display region SC12 are determined and switched by the processing unit 31A based on a display order each time a slide of a shared material displayed in the shared material display region SC11 is switched by an operation of the distributor TC, each predetermined time (for example, 3 minutes, 5 minutes, 10 minutes, or the like) set in advance, or each time an operation of the distributor TC for requesting to switch viewer images is received.

Interest level distribution images generated by the comparison unit 31B in the processor 31 are displayed in the interest level distribution information display region SC13. The comparison unit 31B classifies an N number of viewers (N is an integer equal to or larger than 2) into groups of h (h is an integer equal to or larger than 2) stages based on the interest levels of viewers recorded in the index value table TB1 (see FIG. 12). For example, in the example shown in FIG. 3, the comparison unit 31B classifies viewers into groups of three stags, that is, classifies viewers having interest levels of “0.6 to 1.0” into “a group having a very high interest level”, classifies viewers having interest levels of “0.4 to 0.6” into “a group having a high interest level”, and classifies viewers having interest levels of “0.0 to 0.4” into “a group having a low interest level”, based on the interest levels of the viewers recorded in the index value table TB1. A value of h and a range of the interest levels for classifying viewers into a group may be set to any value by the distributor TC.

The comparison unit 31B calculates the number of viewers or a ratio of viewers in each group after the classification, and generates an interest level distribution image in which the calculated number of viewers or the calculated ratio of viewers in each group is displayed on an icon (at an upper side of the paper) corresponding to each of the three groups of “a group having a very high interest level”, “a group having a high interest level”, and “a group having a low interest level”. The comparison unit 31B generates the video distribution screen SC1 including the generated interest level distribution image in the interest level distribution information display region SC13, and displays the video distribution screen SC1 on the display unit 16. In the example shown in FIG. 3, a ratio of viewers classified into the “group having a very high interest level” is “50”, a ratio of viewers classified into the “group having a high interest level” is “30”, and a ratio of viewers classified into the “group having a low interest level” is “20”.

As a result, the distributor terminal PT1 visualizes and presents current interest levels of viewers to the distributor TC. The distributor TC can check at a glance whether each viewer is interested in current distribution contents based on the interest level distribution information displayed in the interest level distribution information display region SC13.

Next, the video distribution screen SC2 displayed on the display unit 26 of each of the viewer terminals PS1 will be described with reference to FIG. 4. FIG. 4 is a view showing a use case example of the viewer terminals PS1 and an example of the video distribution screen SC2. A display layout of the video distribution screen SC2 shown in FIG. 4 is an example, and the present invention is not limited thereto.

The imaging unit 23 shown in the use case example in FIG. 4 is installed at a position where the imaging unit 23 can image the face of a viewer CS. It is needless to say that the installation position of the imaging unit 23 is not limited to a position on the display unit 26 as long as the imaging unit 23 can image the face of the viewer CS.

The input unit 24 shown in the use case example in FIG. 4 is implemented by a keyboard and a mouse. For example, each of the voice input unit 25A and the voice output unit 25B is implemented by a headphone with a microphone.

The display unit 26 shown in the use case example in FIG. 4 displays a video distribution screen including a shared material display region SC21 and a distributor image display region SC22. A shared material for an online video distribution designated by an operation of the distributor TC is displayed in the shared material display region SC21. A distributor image transmitted from the distributor terminal PT1 is displayed in the distributor image display region SC22.

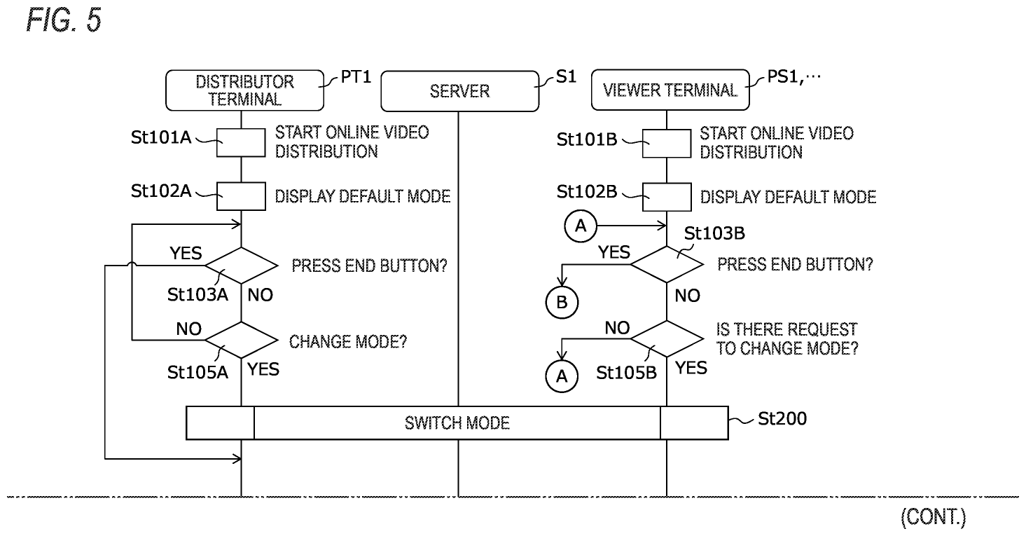

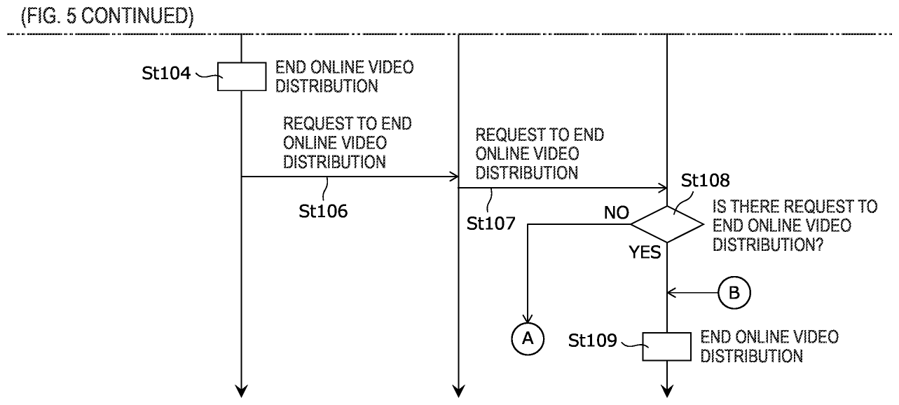

Here, an operation procedure in the default mode of the online video distribution support system 100 according to the first embodiment will be described with reference to FIG. 5. FIG. 5 is a sequence diagram showing an example of an operation procedure in the default mode of the online video distribution support system 100 according to the first embodiment.

The distributor terminal PT1 starts the online video distribution based on an operation of the distributor TC (St101A). The distributor terminal PT1 displays, on the display unit 16, the video distribution screen SC1 (see FIG. 3) corresponding to the lecture mode that is a default mode set in advance (St102A).

Specifically, when the distributor terminal PT1 receives an operation for starting the online video distribution from the distributor TC, the distributor terminal PT1 generates a control command for requesting the start of the online video distribution and transmits the control command to the server S1. The server S1 transmits information of an address of the main venue used in the online video distribution to the distributor terminal PT1 based on the control command transmitted from the distributor terminal PT1. After the distributor terminal PT1 accesses the main venue transmitted from the server S1, the distributor terminal PT1 transmits, to the server S1, voice of the distributor TC collected by the voice input unit 15A, a distributor image captured by the imaging unit 13, biological information and the position information of the line of sight of the distributor TC acquired using the distributor image, data of a shared material designated by the distributor TC, identification information of the distributor TC or the distributor terminal PT1, and the like. The server S1 generates the video distribution screen SC1 (see FIG. 3) based on these pieces of data transmitted from the distributor terminal PT1, and transmits the video distribution screen SC1 to the distributor terminal PT1. The distributor terminal PT1 displays the video distribution screen SC1 transmitted from the server S1 on the display unit 16.

The video distribution screen SC1 may not include the shared material display region SC11, the viewer image display region SC12, and the interest level distribution information display region SC13 (that is, the viewer images and the viewer bird's eye view information). For example, the distributor TC may select to display or not display the viewer image display region SC12, and when no viewer image is transmitted from each of the viewer terminals PS1 (that is, when no viewer participates, when no viewer image is transmitted from a viewer terminal, or the like), the viewer image display region SC12 may be not displayed. The distributor TC may select to display or not display the interest level distribution information display region SC13, and the interest level distribution information display region SC13 may be not displayed until the viewer bird's eye view information (see FIG. 3) is generated.

The distributor terminal PT1 determines whether an end button (not shown) for ending the online video distribution displayed on the video distribution screen SC1 is pressed (selected) by an operation of the distributor TC (St103A).

When it is determined in the processing of step St103A that the end button for ending the online video distribution is pressed (selected) (St103A, YES), the distributor terminal PT1 ends the online video distribution (St104).

On the other hand, when it is determined in the processing of step St103A that the end button for ending the online video distribution is not pressed (selected) (St103A, NO), the distributor terminal PT1 determines whether an operation of changing a mode of the online video distribution is performed by the distributor TC (that is, whether there is a mode change) (St105A).

Here, an operation procedure of each of the plurality of viewer terminals PS1 will be described.

Each of the plurality of viewer terminals PS1 starts the online video distribution based on an operation of a viewer (St101B). Each of the plurality of viewer terminals PS1 displays the video distribution screen SC2 (see FIG. 4) on the display unit 26 (St102B).

Specifically, after each of the plurality of viewer terminals PS1 accesses the main venue, each of the plurality of viewer terminals PS1 transmits, to the server S1, a viewer image captured by the imaging unit 23, biological information and position information of the line of sight of a viewer acquired using the viewer image, identification information of a viewer or a viewer terminal, and the like. The server S1 generates the video distribution screen SC2 (see FIG. 4) based on these pieces of data transmitted from each of the plurality of viewer terminals PS1 and various kinds of data transmitted from the distributor terminal PT1, and transmits the video distribution screen SC2 to each of the plurality of viewer terminals PS1. Each of the plurality of viewer terminals PS1 displays the video distribution screen SC2 transmitted from the server S1 on the display unit 26.

Each of the plurality of viewer terminals PS1 determines whether an end button (not shown) for ending the online video distribution displayed on the video distribution screen SC2 is pressed (selected) by an operation of a viewer (St103B).

When it is determined in the processing of step St103B that the end button for ending the online video distribution is pressed (selected) (St103B, YES), each of the plurality of viewer terminals PS1 ends the online video distribution (St109).

On the other hand, when it is determined in the processing of step St103B that the end button for ending the online video distribution is not pressed (selected) (St103B, NO), each of the plurality of viewer terminals PS1 determines whether an operation of changing a mode of the online video distribution is performed by the distributor TC (that is, whether there is a mode change) (St105B).

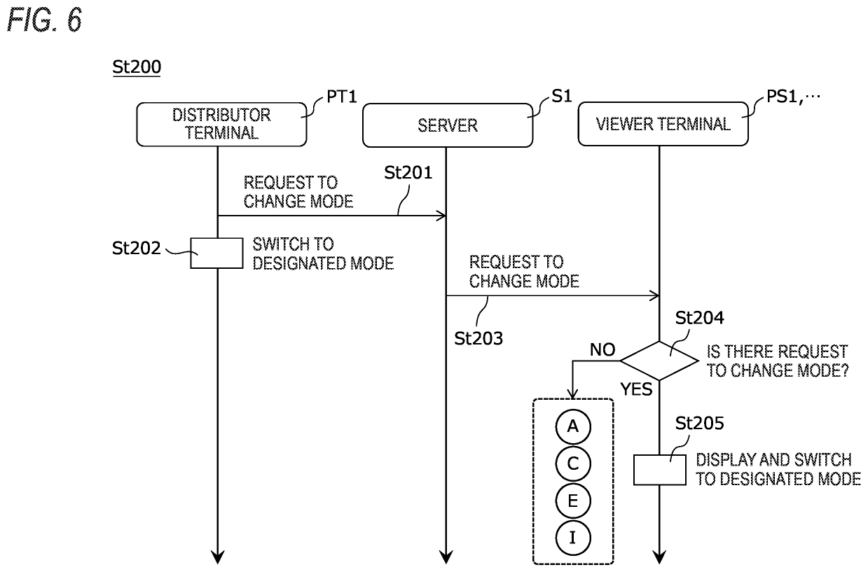

When it is determined in the processing of step St105B that the operation of changing a mode of the online video distribution is performed by the distributor TC (St105B, YES), each of the plurality of viewer terminals PS1 proceeds the procedure to step St200. A mode change processing shown in step St200 will be described later with reference to FIG. 6.

On the other hand, when it is determined in the processing of step St105B that the operation of changing a mode of the online video distribution is not performed by the distributor TC (St105B, NO), each of the plurality of viewer terminals PS1 proceeds the procedure to the processing of step St103B, and determines whether the end button for ending the online video distribution is pressed (selected).

When it is determined in the processing of step St105A that the operation of changing a mode of the online video distribution is performed by the distributor TC (St105A, YES), the distributor terminal PT1 proceeds the procedure to step St200 and executes a processing of changing a current mode (here, the lecture mode) to a mode designated by the distributor TC (a mode change processing). A mode change processing shown in step St200 will be described later with reference to FIG. 6.

On the other hand, when it is determined in the processing of step St105A that the operation of changing a mode of the online video distribution is not performed by the distributor TC (St105A, NO), the distributor terminal PT1 proceeds the procedure to the processing of step St103A, and determines whether the end button for ending the online video distribution is pressed (selected).

The distributor terminal PT1 generates a control command for requesting to end the online video distribution and transmits the control command to the server S1 (St106).

Based on the control command transmitted from the distributor terminal PT1, the server S1 transmits the control command for requesting to end the online video distribution to each of the plurality of viewer terminals PS1 (St107).

Each of the plurality of viewer terminals PS1 determines whether the control command that is used for requesting to end the online video distribution and transmitted from the server S1 (specifically, the control command for requesting to end the online video distribution) is received (St108).

When it is determined in the processing of step St108 that the control command transmitted from the server S1 is received (St108, YES), each of the plurality of viewer terminals PS1 ends the online video distribution (St109).

On the other hand, when it is determined in the processing of step St108 that the control command transmitted from the server S1 is not received (St108, NO), each of the plurality of viewer terminals PS1 proceeds the procedure to the processing of step St103B.

Next, the mode change processing will be described with reference to FIG. 6. FIG. 6 is a sequence diagram showing an example of a mode change procedure of the online video distribution support system 100 according to the first embodiment. Although an example in which a mode is changed from the default mode to another mode will be described in the example shown in FIG. 6, the present invention is not limited thereto.

When it is determined in the processing of step St105A that the operation of changing a mode of the online video distribution is performed by the distributor TC (St105A, YES), the distributor terminal PT1 proceeds the mode change processing to step St200 and executes a processing of changing a current mode (here, the lecture mode) to a mode designated by the distributor TC (a mode change processing).

The distributor terminal PT1 generates a control command for requesting to change the current mode (for example, the lecture mode) to a mode designated by the distributor TC, and transmits the control command to the server S1 (St201). The distributor terminal PT1 changes the mode of the online video distribution to the mode designated by the distributor TC (St202).

Based on the control command transmitted from the distributor terminal PT1, the server S1 transmits the control command for requesting to end the online video distribution to each of the plurality of viewer terminals PS1 (St203).

Each of the plurality of viewer terminals PS1 determines whether the control command that is used for requesting to end the online video distribution and transmitted from the server S1 (specifically, the control command for requesting to end the online video distribution) is received (St204).

When it is determined in the processing of step St204 that the control command transmitted from the server S1 is received (St204, YES), each of the plurality of viewer terminals PS1 ends the online video distribution (St205).

On the other hand, when it is determined in the processing of step St204 that the control command transmitted from the server S1 is not received (St204, NO), each of the plurality of viewer terminals PS1 proceeds the mode change processing to the processing of step St103B.

Here, when the online video distribution is in the lecture mode and the mode change processing proceeds from the processing of step St312 to the processing of step St200, the mode change processing proceeds to the processing of step St304 after the processing of step St204. When the online video distribution is in the group discussion mode and the mode change processing proceeds from the processing of step St411 to the processing of step St200, the mode change processing proceeds to the processing of step St407 after the processing of step St204. Similarly, when the online video distribution is in the question mode and the mode change processing proceeds from the processing of step St514 to the processing of step St200, the mode change processing proceeds to the processing of step St501B after the processing of step St204.

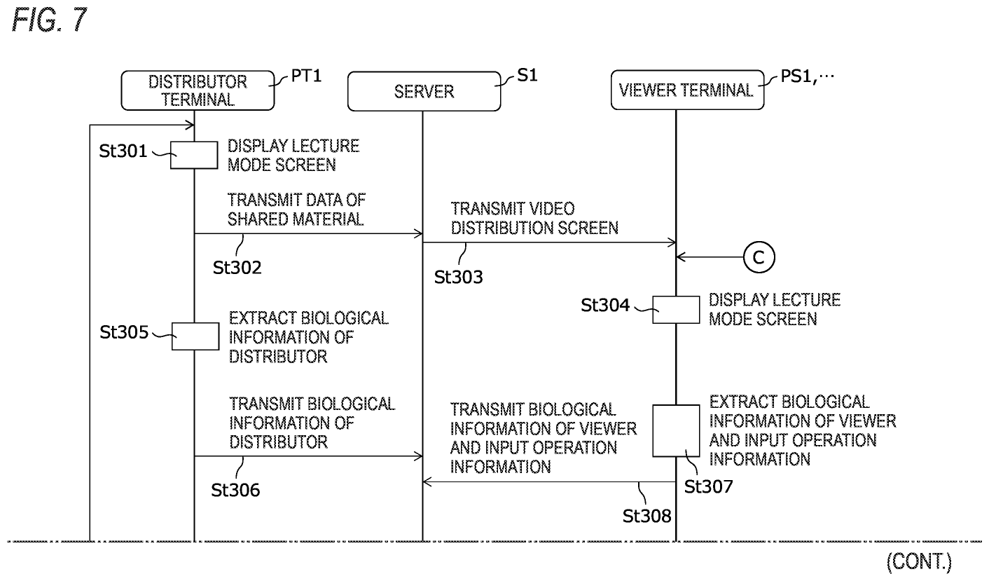

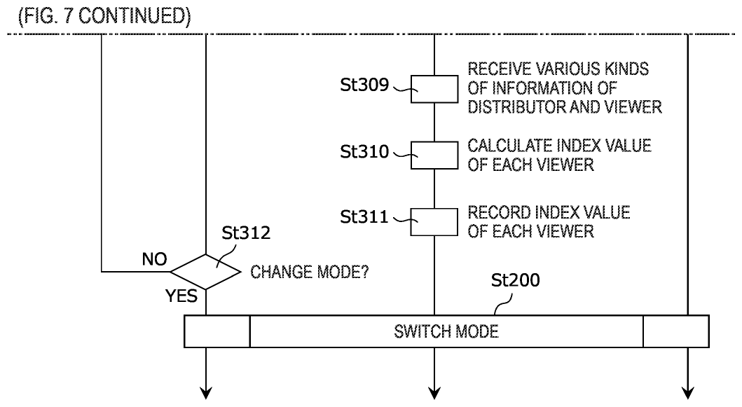

An example of an operation procedure in the lecture mode will be described with reference to FIG. 7. FIG. 7 is a sequence diagram showing an example of an operation procedure in the lecture mode of the online video distribution support system 100 according to the first embodiment.

When a mode of the online video distribution is changed to the lecture mode, the distributor terminal PT1 displays the video distribution screen SC1 (see FIG. 3) that is a lecture mode screen transmitted from the server S1 on the display unit 16 (St301). The video distribution screen SC1 displayed on the display unit 16 in the processing of step St301 may not include the shared material display region SC11, the viewer image display region SC12, and the interest level distribution information display region SC13 (that is, a shared material, a viewer image, and viewer bird's eye view information). A shared material is displayed in the shared material display region SC11 after the processing of step St302 to be described below on the video distribution screen SC1 in the operation procedure example shown in FIG. 7.

The distributor terminal PT1 transmits data of the shared material designated by the distributor TC to the server S1 (St302). The shared material referred to here is a slide material including a plurality of pieces of image data for presentation, a PDF material, live video (moving image) data, recorded video (moving image) data, image data, or the like. The shared material may be data transmitted from a viewer terminal of any viewer permitted or designated by the distributor TC. In such a case, the shared material is transmitted from the viewer terminal to the server S1.

The server S1 generates the video distribution screen SC1 on which data of a shared material transmitted from the distributor terminal PT1 is displayed in the shared material display region SC11 and the video distribution screen SC2 on which data of a shared material is displayed in the shared material display region SC21. The server S1 transmits the generated video distribution screen SC1 to the distributor terminal PT1 and causes the distributor terminal PT1 to display the video distribution screen SC1. The server S1 transmits the generated video distribution screen SC2 to each of the plurality of viewer terminals PS1 (St303).

Each of the plurality of viewer terminals PS1 displays the video distribution screen SC2 (see FIG. 4) that is a lecture mode screen transmitted from the server S1 on the display unit 26 (St304).

The distributor terminal PT1 extracts biological information of the distributor TC from a distributor image obtained by imaging the distributor TC (St305). Here, the biological information includes a position of the line of sight, facial expression, heartbeat, heartbeat fluctuation, voice, brain waves, and the like.

The distributor terminal PT1 transmits the extracted biological information of the distributor TC, imaging time of the distributor image used for extracting the biological information, and identification information of the distributor TC or the distributor terminal PT1 to the server S1 in association with one another (St306).

Each of the plurality of viewer terminals PS1 extracts biological information of a viewer from a viewer image obtained by imaging the viewer or voice data obtained by collecting voice of the viewer (St305). The biological information referred to here may be a position of the line of sight, facial expression, heartbeat, heartbeat fluctuation, voice, brain waves, or the like, or may be a relaxation level, a concentration level, a stress level, or the like of a viewer that is estimated (evaluated) by analyzing the position of the line of sight, the expression, the heartbeat, the heartbeat fluctuation, the voice, the brain waves, or the like. Further, the biological information may be various kinds of input information input to the input unit 24 by a viewer, or may be a relaxation level, a concentration level, a stress level, or the like of a viewer that is estimated (evaluated) by analyzing the various kinds of input information. The various kinds of input information referred to here include, for example, an input operation history to a user interface such as a mouse or a keyboard, an input history input to a chat field, answer contents input by a viewer to a small test, a questionnaire, a question, or the like distributed from the distributor terminal PT1 during an online video distribution, the number of utterances or utterance contents during an online video distribution, and the like.

Each of the plurality of viewer terminals PS1 transmits, to the server S1, the extracted biological information of a viewer, imaging time of a viewer image used for extracting the biological information, voice collection time of voice data of the viewer, or input time of various kinds of input information, and identification information of a viewer or a viewer terminal in association with one another (St308).

The server S1 receives the biological information of the distributor TC transmitted from the distributor terminal PT1 and various kinds of information (for example, the imaging time of the distributor image, the identification information of the distributor TC or the distributor terminal PT1, and the like) associated with the biological information (St309). The server S1 receives the biological information of a viewer transmitted from each of the plurality of viewer terminals PS1 and various kinds of information (for example, the imaging time of a viewer image, the voice collection time of voice data of the viewer, the input time of various kinds of input information, the identification information of the viewer or the viewer terminal, and the like) associated with the biological information (St309).

The server S1 calculates various parameters for each viewer, and calculates (evaluates) an index value for each viewer based on the calculated various parameters (St310). The various parameters referred to here include an interest level, an understanding level, a sympathy level, and the like. The index value is a value used for a viewer grouping processing in the group discussion mode to be described later or used for selecting a questioner candidate in the question mode. An index value calculation method is set by the distributor TC. The server S1 calculates an index value using a parameter, a weight coefficient, and the like used for calculating the set index value.

The server S1 records the calculated (evaluated) various parameters and index values for each viewer in the index value table TB1 of the memory 32 (St311). The server S1 may record, in the memory 32, various kinds of information of the distributor TC and each of the plurality of viewers that are received in step St309.

The distributor terminal PT1 determines whether an operation of changing a mode of the online video distribution is performed by the distributor TC (that is, whether there is a mode change) (St312).

When it is determined in the processing of step St312 that the operation of changing a mode of the online video distribution is performed by the distributor TC (St312, YES), the distributor terminal PT1 proceeds the procedure to step St200 and executes a processing of switching from a current mode (here, the lecture mode) to a mode designated by the distributor TC (a mode change processing).

On the other hand, when it is determined in the processing of step St312 that the operation of changing a mode of the online video distribution is not performed by the distributor TC (St312, NO), the distributor terminal PT1 proceeds the procedure to the processing of step St301. That is, the distributor terminal PT1 repeatedly executes the processings of steps St301 to St302 and steps St305 to St306 in the lecture mode.

As described above, during the lecture mode, the online video distribution support system 100 according to the first embodiment can calculate and record index values used for a viewer grouping processing in the group discussion mode to be described later or used for selecting a questioner candidate in the question mode.

The online video distribution support system 100 acquires and records various kinds of information of the distributor TC and various kinds of information of each of the plurality of viewers necessary for calculating an index value during the lecture mode. Accordingly, even when setting of an index value calculation method is changed by the distributor TC, the online video distribution support system 100 can calculate (evaluate) an index value for each viewer based on biological information of the distributor TC accumulated and recorded over a predetermined period in the past (for example, one hour, one week, one month, or the like), biological information of each of the plurality of viewers, various kinds of input information, and the like.

When another online video distribution is performed by the same distributor TC, the online video distribution support system 100 can calculate (evaluate) an index value for each viewer based on various kinds of information of the distributor TC and various kinds of information of a plurality of viewers accumulated and recorded over a predetermined period in the past (for example, one hour, one week, one month, or the like). Further, even when another online video distribution is performed by another distributor, the online video distribution support system 100 can calculate (evaluate) an index value based on variations in various parameters (for example, a change in an interest level, an understanding level, a sympathy level, and the like) for each viewer by referring to biological information, various kinds of input information, and the like of each of the plurality of viewers accumulated and recorded over a predetermined period in the past (for example, one hour, one week, one month, and the like).

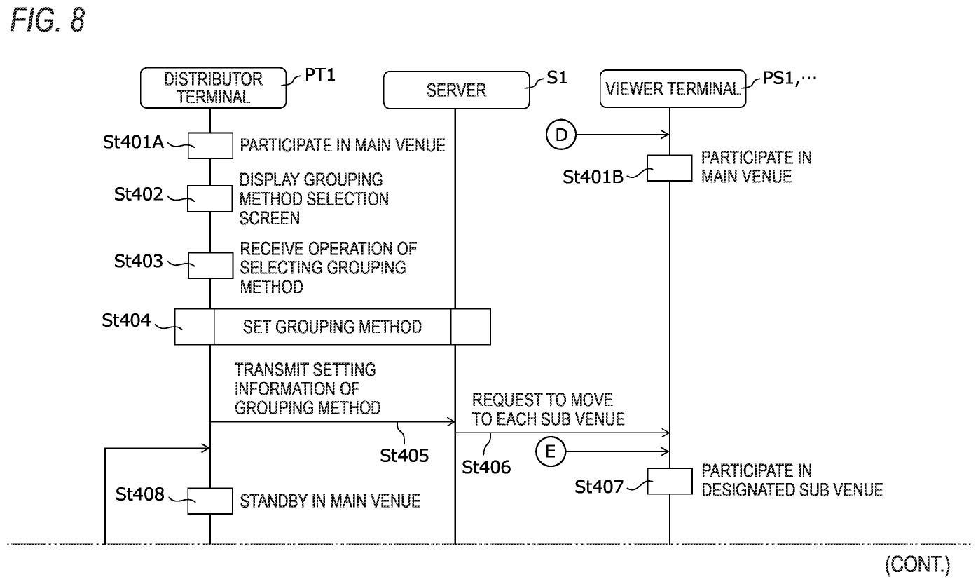

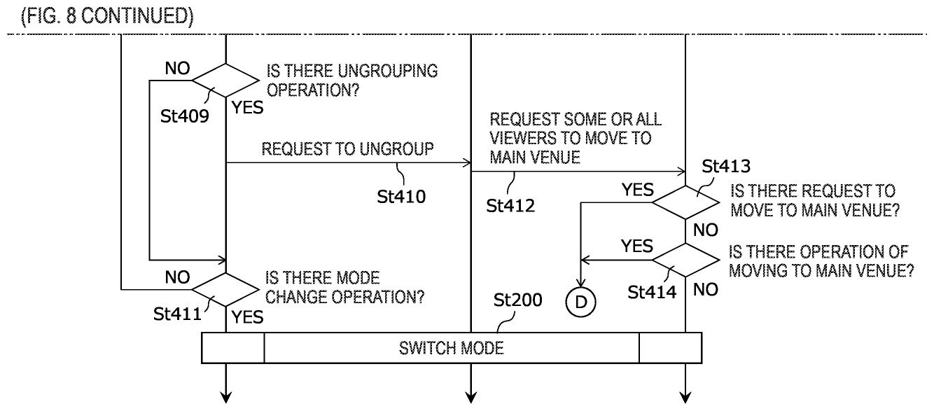

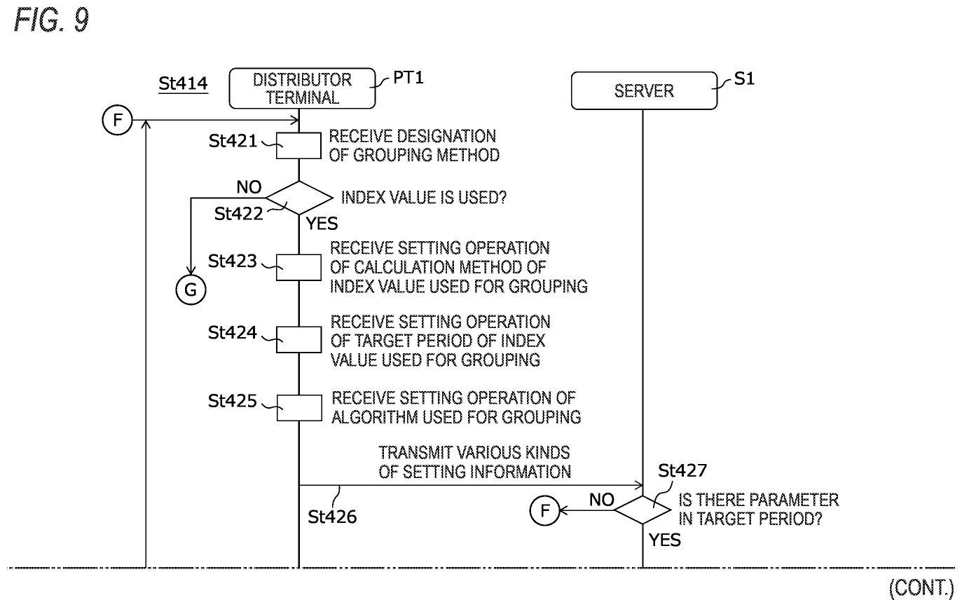

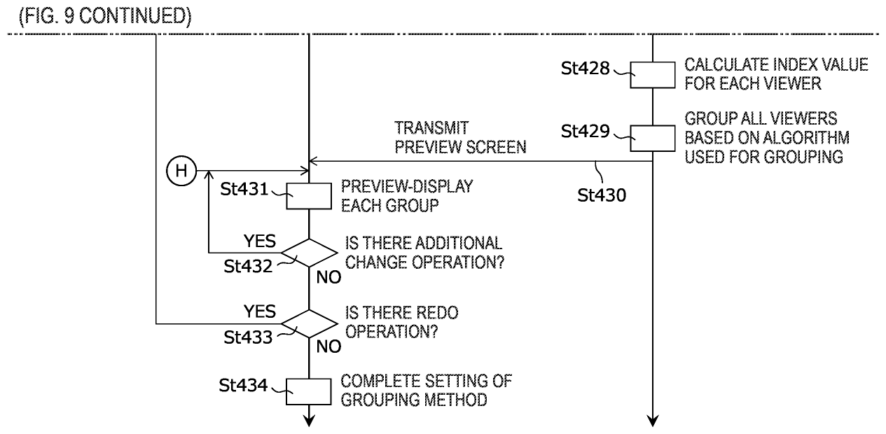

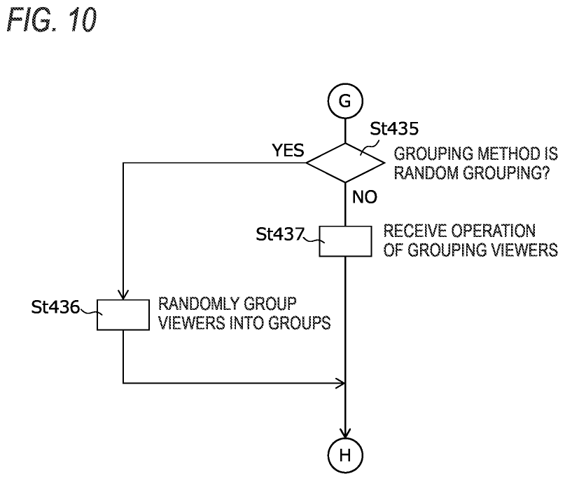

An example of an operation procedure in the group discussion mode will be described with reference to FIGS. 8 to 10. FIG. 8 is a sequence diagram showing an example of a setting procedure of a grouping method in the online video distribution support system 100 according to the first embodiment. FIG. 9 is a sequence diagram showing an example of a grouping procedure of the online video distribution support system 100 according to the first embodiment. FIG. 10 is a sequence diagram showing an example of a grouping procedure of the online video distribution support system 100 according to the first embodiment.

Although a case including a procedure of selecting and setting a grouping method for group discussion will be described in the example of the operation procedure shown in FIG. 8, the selection or setting of the grouping method for group discussion may be performed by the distributor TC during another mode or before the start of the online video distribution.

Similarly, when a mode is changed from another mode to the group discussion mode, each of the plurality of viewer terminals PS1 is brought into a state of accessing (participating in) the main venue (St401B).

When a mode is changed from another mode to the group discussion mode, in a state in which the distributor terminal PT1 accesses (participates in) the main venue (St401A), the distributor terminal PT1 generates and displays a grouping method selection screen (not shown) capable of accepting an operation of selecting a grouping method by the distributor TC (St402). For example, the grouping method selection screen may be a screen for selecting whether to change the setting of a currently set grouping method, or may be a screen including an input field, a selection field, and the like of various kinds of setting information that can be set by the distributor TC in the processing of step St414 to be described later.

The distributor terminal PT1 receives an operation of the distributor TC on the grouping method selection screen (St403), and executes a grouping method setting processing (St404).

Here, the grouping method setting processing in step St414 will be described in detail.

The distributor terminal PT1 receives designation of a grouping method by an operation of the distributor TC (St421). The grouping method referred to here is, for example, a method of grouping viewers by a manual operation of the distributor TC, a method of grouping viewers at random regardless of various parameters or index values calculated for each viewer, a method of grouping viewers based on various parameters or index values calculated for each viewer, or the like.

The distributor terminal PT1 determines whether a grouping method designated by the distributor TC is a grouping method using various parameters or index values (that is, a method of grouping viewers based on various parameters or index values calculated for each viewer) (St422).

When it is determined in the processing of step St422 that the grouping method designated by the distributor TC is a grouping method using various parameters or index values (St422, YES), the distributor terminal PT1 receives an operation of the distributor TC for setting an index value calculation method used for grouping (St423).

Here, the index value calculation method used for grouping set in step St423 may be a method of simply calculating any parameter (an interest level, an understanding level, or a sympathy level) as the index value, or may be a method of calculating the index value by combining two or more parameters. Further, when setting the index value calculation method, the distributor terminal PT1 may receive an operation of the distributor TC for setting a weight coefficient for each of the various parameters, a weight coefficient for each of various kinds of biological information used for calculating the various parameters, and a weight coefficient for each of various kinds of data (for example, line-of-sight movement line data, a line-of-sight heat map, and the like). A method of generating various kinds of data will be described later.

On the other hand, when it is determined in the processing of step St422 that the grouping method designated by the distributor TC is not a grouping method using various parameters or index values (for example, a method of manually grouping, a method of randomly grouping, or the like) (St422, NO), the distributor terminal PT1 proceeds the grouping method setting processing to the processing of step St435.

The distributor terminal PT1 receives an operation of the distributor TC for setting a target period of the index value used for grouping (St424). Specifically, the distributor terminal PT1 receives a designation operation related to date and time when various parameters used for calculating the index value are calculated, imaging time of a distributor image and a viewer image that are used for calculating various parameters, voice collection time of voice data of a viewer, input time of various kinds of input information, or the like. Accordingly, for example, in a case where an online video distribution is performed periodically, such as an online lecture (class) performed several times, or in a case where an online video distribution related to distribution contents is performed, the online video distribution support system 100 can calculate an index value including various parameters calculated in a past online video distribution, or can set a change amount of an interest level, an understanding level, or a sympathy level of each viewer based on various parameters calculated in the past as the index value.

The distributor terminal PT1 receives an operation of the distributor TC for setting an algorithm used for grouping (St425). The algorithm referred to here is, for example, an algorithm for grouping viewers into groups such that an average value of index values of a plurality of viewers included in each group after the grouping is approximately the same in each group, an algorithm for rearranging a plurality of viewers in descending order or ascending order of index values and grouping the rearranged viewers into each predetermined number (for example, three, four, and five), or the like.

The distributor terminal PT1 transmits, to the server S1, various kinds of setting information used for grouping set in the processings of steps St423 to St425 (St426).

The server S1 records the setting information used for grouping transmitted from the distributor terminal PT1 in the memory 32, and refers to the index value table TB1 recorded in the memory 32 to determine whether there are various parameters recorded in a target period included in the various kinds of setting information (St427). Although an example in which it is determined whether there are various parameters is shown here, the server S1 may determine whether there are biological information of the distributor TC and biological information of a viewer that are used to calculate the various parameters.

Further, the server S1 may determine in the processing of step St427 whether there are various parameters of one or more viewers among viewers who are currently viewing the online video distribution. As a result, the online video distribution support system 100 can execute a grouping processing even when there is a viewer who starts to view the online video distribution in the middle of the online video distribution.

When it is determined in the processing of step St427 that there are various parameters recorded in the target period included in the various kinds of setting information

(St427, YES), the server S1 calculates an index value for each viewer based on the index value calculation method set in the processing of step St423 (St428).

On the other hand, when it is determined in the processing of step St427 that there are no various parameters recorded in the target period included in the various kinds of setting information (St427, NO), the server S1 proceeds the grouping method setting processing to the processing of step St421, and receives an operation of designating a grouping method from the distributor TC again (St421).

The server S1 groups a plurality of viewers into two or more groups based on the algorithm for grouping and the calculated index value (St429). The server S1 generates the preview screens SC9 and SC10 (see FIGS. 19 and 20) on which a plurality of viewer images are grouped into groups, and transmits the preview screens SC9 and SC10 to the distributor terminal PT1 (St430).

The distributor terminal PT1 preview-displays the preview screens SC9 and SC10 (see FIGS. 19 and 20) of the groups transmitted from the server S1 on the display unit 16 (St431), and receives an additional change operation of the distributor TC on a grouping result of the groups based on the preview screens. The distributor terminal PT1 determines whether there is an additional change operation of the distributor TC (St432).

When it is determined in the processing of step St432 that there is an additional change operation of the distributor TC (St432, YES), the distributor terminal PT1 changes viewers grouped into each group based on the additional change operation of the distributor

TC, generates the preview screens SC9 and SC10 (see FIGS. 19 and 20) based on a grouping result of each group after the change, and displays the preview screens SC9 and SC10 on the display unit 16 (St431).

On the other hand, when it is determined in the processing of step St432 that there is no additional change operation of the distributor TC (St432, NO), the distributor terminal PT1 determines whether there is an operation of requesting the distributor TC to reset the grouping method (St433).

when it is determined in the processing of step St433 that there is an operation of requesting the distributor TC to reset the grouping method (St433, YES), the distributor terminal PT1 receives an operation of designating the grouping method from the distributor TC again (St421).

On the other hand, when it is determined in the processing of step St433 that there is no operation of requesting the distributor TC to reset the grouping method (St433, NO), the distributor terminal PT1 generates setting information of a grouping method that is currently set, and completes the grouping method setting processing (St434).

Here, the grouping method setting processing in a case where no index value is used will be described.

When it is determined in the processing of step St422 that the grouping method designated by the distributor TC is not a grouping method using various parameters or index values (St422, NO), the distributor terminal PT1 further determines whether the set grouping method is a method of randomly grouping a plurality of viewers (St435).

When it is determined in the processing of step St435 that the grouping method is a method of randomly grouping a plurality of viewers (St435, YES), the distributor terminal PT1 randomly assigns and groups the plurality of viewers into two or more groups (St436). The distributor terminal PT1 may receive a designation operation of the distributor TC related to the number of groups in which a plurality of viewers are randomly grouped, the number of viewers grouped into one group, and the like. The distributor terminal PT1 executes a grouping processing based on the number of groups or the number of persons designated by the distributor TC. The distributor terminal PT1 generates the preview screens SC9 and SC10 (see FIGS. 19 and 20) based on a grouping result, and displays the preview screens SC9 and SC10 on the display unit 16 (St431).

On the other hand, when it is determined in the processing of step St435 that the grouping method is not a method of randomly grouping a plurality of viewers (St435, NO), the distributor terminal PT1 receives an operation of grouping the viewers from the distributor TC (St437). The distributor terminal PT1 generates the preview screens SC9 and SC10 (see FIGS. 19 and 20) of the groups of viewers grouped by the operation of the distributor TC, and displays the preview screens SC9 and SC10 on the display unit 16 (St431).

As described above, the online video distribution support system 100 according to the first embodiment can set a grouping method for a plurality of viewers. Hereinafter, a grouping processing based on the grouping method set by the operation procedure shown in FIGS. 9 and 10 will be described again with reference to the operation procedure shown in FIG. 8.

The distributor terminal PT1 transmits the generated setting information of the grouping method to the server S1 (St405).

The server S1 records the setting information of the grouping method transmitted from the distributor terminal PT1 in the memory 32, and executes the grouping processing. The server S1 generates address information of a sub venue for each of the generated two or more groups based on a grouping result, associates the address information of the sub venue for performing an online video distribution in each group with a control command for requesting to move to (access) the address of the sub venue, and transmits the associated information to a viewer terminal corresponding to the address information of the sub venue (St406). The server S1 may associate the address information of the sub venue corresponding to each group with information related to viewers grouped into each group, and transmit the associated information to the distributor terminal PT1.

Each of the plurality of viewer terminals PS1 moves (accesses) from the currently accessed main venue to the sub venue based on the control command transmitted from the server S1 (St407). The processing of step St407 may be executed based on a viewer operation.

The distributor terminal PT1 is in standby in the main venue during a period when each of the plurality of viewers performs an online video distribution in a sub venue of a grouping destination (St408). When address information of a sub venue corresponding to each group and information of viewers grouped into each group are transmitted from the server S1, the distributor terminal PT1 may move to each sub venue and view an online video distribution performed in each group.

The distributor terminal PT1 determines whether there is an ungrouping operation from the distributor TC (St409).

When it is determined in the processing of step St409 that there is an ungrouping operation performed by the distributor TC (St409, YES), the distributor terminal PT1 generates a control command for requesting ungrouping and transmits the control command to the server S1 (St410). Here, the distributor terminal PT1 may generate a control command for ungrouping some groups based on an operation of the distributor TC and transmit the control command to the server S1.

On the other hand, when it is determined in the processing of step St409 that there is no ungrouping operation performed by the distributor TC (St409, NO), the distributor terminal PT1 determines whether there is an operation of the distributor TC for changing a mode of the online video distribution (St411). When it is determined in the processing of step St411 that there is an operation of by the distributor TC for changing a mode of the online video distribution (St411, YES), the distributor terminal PT1 proceeds the grouping processing to the processing of step St200. On the other hand, when it is determined in the processing of step St411 that there is no operation of the distributor TC for changing a mode of the online video distribution performed (NO in step St411), the distributor terminal PT1 proceeds the grouping processing to the processing of step St408 and continues the standby state in the main venue (St408).

Based on the control command transmitted from the distributor terminal PT1, the server S1 transmits a control command for requesting movement (access) to the main venue and an address for moving to the main venue in association with each other to each of the plurality of viewer terminals PS1 (St412). When the control command transmitted from the distributor terminal PT1 is a control command for ungrouping some groups, the server S1 may transmit a control command for requesting movement (access) to the main venue and an address for moving to the main venue to each of a plurality of viewer terminals grouped into a corresponding group in association with each other.

Each of the plurality of viewer terminals PS1 determines whether there is a control command (that is, a movement request) for requesting movement (access) to the address of the main venue from the server S1 (St413).

When it is determined in the processing of step St413 that there is a control command for requesting movement (access) to the address of the main venue from the server S1 (St413, YES), each of the plurality of viewer terminals PS1 proceeds the grouping processing to the processing of step St401B.

On the other hand, when it is determined in the processing of step St413 that there is no control command for requesting movement (access) to the address of the main venue from the server S1 (St413, NO), each of the plurality of viewer terminals PS1 determines whether there is an operation of a viewer for moving (accessing) to the address of the main venue (St414).

When it is determined in the processing of step St414 that there is an operation of the viewer for moving to (accessing) the address of the main venue (St414, YES), each of the plurality of viewer terminals PS1 proceeds the grouping processing to the processing of step St401B.

On the other hand, when it is determined in the processing of step St414 that there is no operation of the viewer for moving to (accessing) the address of the main venue (St414, NO), each of the plurality of viewer terminals PS1 proceeds the grouping processing to a determination of determining whether there is a mode change request in step St204. When it is determined in the processing of step St204 that there is no mode change request (St204, NO), each of the plurality of viewer terminals PS1 proceeds the grouping processing to the processing of step St407 and each of the plurality of viewer terminals PS1 is in standby in a designated sub venue.

As described above, when a mode is changed to the group discussion mode in the online video distribution, the online video distribution support system 100 according to the first embodiment can group a plurality of viewers into a plurality of groups based on setting information of a grouping method set by the distributor TC. The setting procedures of the grouping method shown in FIGS. 9 and 10 may be executed during a mode other than the group discussion mode or may be executed before the start of the online video distribution. As a result, the online video distribution support system 100 can execute the grouping processing during the online video distribution more smoothly.

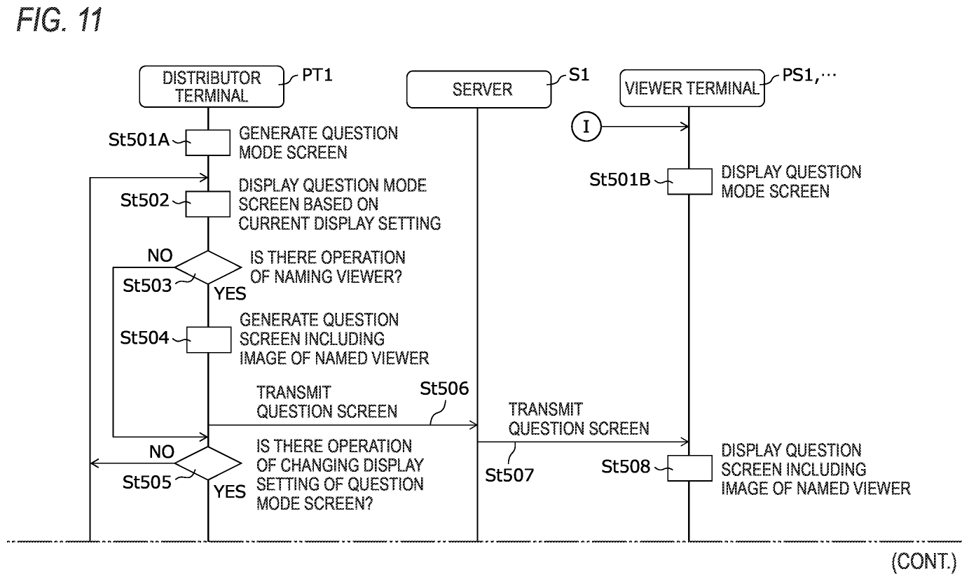

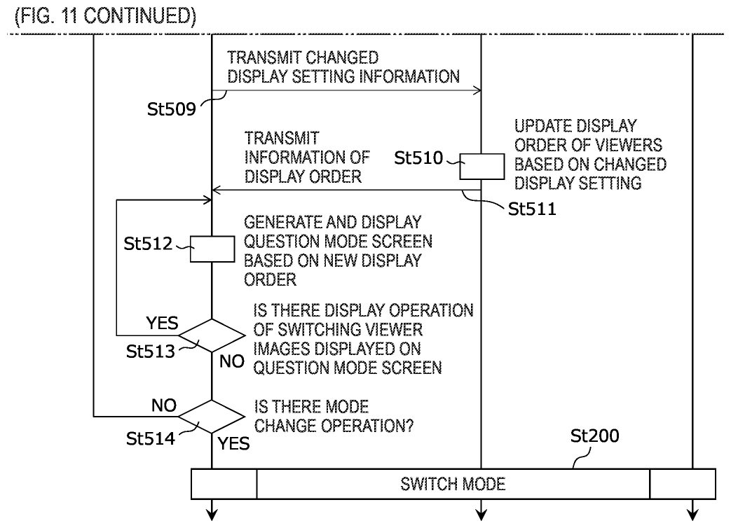

An example of an operation procedure in the question mode will be described with reference to FIG. 11. FIG. 11 is a sequence diagram showing an example of an operation procedure in the question mode of the online video distribution support system 100 according to the first embodiment. The question mode screens SC3 and SC4 (see FIGS. 13 and 14) displayed on the distributor terminal PT1 are referred to as a “first question mode screen”, and the question mode screens SC5 and SC6 (see FIGS. 15 and 16) displayed on each of the plurality of viewer terminals PS1 are referred to as a “second question mode screen” in the following description in order to make the description easy to understand.

The distributor terminal PT1 acquires information of a display order of viewer images displayed on the first question mode screen from the server S1 at a timing when a mode is changed to the question mode. The distributor terminal PT1 rearranges the viewer images in a descending display order based on the acquired information of the display order, and selects a predetermined number (for example, three, five, or nine) of viewers (that is, questioner candidates) displayed on the question mode screen from each of the rearranged viewer images of a plurality of viewers. The distributor terminal PT1 generates the first question mode screen (see FIGS. 13 and 14) including viewer images of the predetermined number of the selected viewers in a viewer image display region (St510A). The distributor terminal PT1 displays the generated first question mode screen based on setting information related to current questioner selection (that is, current display setting) on the display unit 16 (St502).

A processing of selecting a questioner candidate and a processing of generating the first question mode screen may be executed by the server S1. In such a case, the server S1 calculates a display order of a plurality of viewers based on the setting information that is related to the selection of questioner candidates, is transmitted in advance from the distributor terminal PT1, and is recorded in the memory 32. Based on the calculated display order, the server S1 selects a predetermined number (for example, three, five, or nine) of viewers (that is, questioner candidates) displayed on the first question mode screen. The server S1 generates the first question mode screen (see FIGS. 13 and 14) including viewer images of the predetermined number of the selected viewers in the viewer image display region, and transmits the first question mode screen to the distributor terminal PT1.

The server S1 may generate the second question mode screen displayed on each of the plurality of viewer terminals PS1 by a generation procedure similar to that of the first question mode screen, or may generate the second question mode screen displayed on each of the plurality of viewer terminals PS1 by another procedure. For example, when setting information related to the selection of a questioner candidate includes setting in which viewer images displayed on the first question mode screen and viewer images displayed on the second question mode screen do not match, the server S1 selects viewer images displayed on the second question mode screen in a manner of not matching viewer images displayed on the first question mode screen. For example, the server S1 may randomly select each of the viewer images displayed on the second question mode screen, or may select a viewer image of at least one viewer among the viewer images displayed on the first question mode screen, and may generate the second question mode screen by changing the selected viewer image of the one or more viewers to a viewer image that is not displayed on the first question mode screen. Further, the server S1 may generate the second question mode screen including a distributor image.

Each of the plurality of viewer terminals PS1 displays the second question mode screen (see FIGS. 15 and 16) transmitted from the server S1 on the display unit 26 at a timing when a mode is changed to the question mode (St501B).

The distributor terminal PT1 determines whether there is an operation of the distributor TC for naming (selecting) any one viewer (that is, a questioner) among viewer images of one or more viewers displayed on the first question mode screen (St503).

The naming (selection) operation may be an operation of pressing (selecting) a viewer image viewer displayed on the first question mode screen (see FIGS. 13 and 14), or may be a voice input operation using voice of the distributor TC or a viewer. In case of the voice input operation, the distributor terminal PT1 executes voice recognition on collected voice data of the distributor TC or the viewer, and based on a name of the viewer, identification information of the viewer, and the like included in the recognition result, the distributor terminal PT1 receives a selection operation of the viewer (questioner) by specifying the named viewer, or receives a selection operation of the viewer (questioner) by analyzing voice data of the viewer and specifying a viewer who replies a call made by the distributor TC using voice recognition.

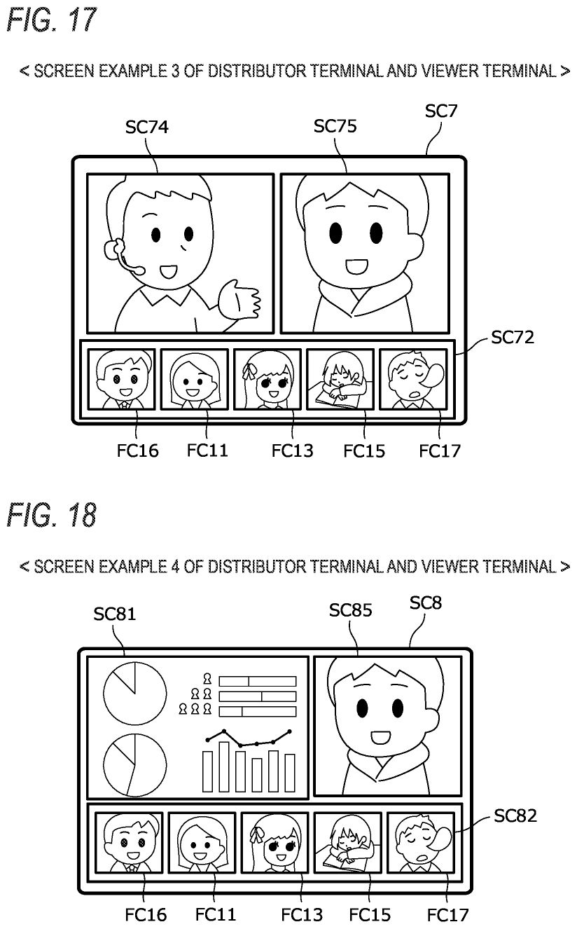

When it is determined in the processing of step St503 that there is a naming (selection) operation of any one viewer (questioner) (St503, YES), the distributor terminal PT1 generates the question mode screens SC7 and SC8 (see FIGS. 17 and 18) including a viewer image of the named viewer (St504), and transmits the question mode screens SC7 and SC8 to the server S1 (St506). The server S1 transmits the question mode screens transmitted from the distributor terminal PT1 to each of the plurality of viewer terminals PS1 (St507). Each of the plurality of viewer terminals PS1 displays, on the display unit 26, the question mode screen that includes the viewer image of the viewer named (selected) by the distributor TC and is transmitted from the server S1 (St508).

Here, the distributor terminal PT1 lowers or resets various parameters, an index value, or a display order corresponding to the named viewer among various parameters, index values, or display orders of a plurality of viewers transmitted from the server S1. Accordingly, the online video distribution support system 100 can prevent a questioner (viewer) once named by the distributor TC from being continuously selected as a questioner candidate, and can select a questioner candidate more efficiently.

On the other hand, when it is determined in the processing of step St503 that there is no naming (selection) operation of any one viewer (questioner) (St503, NO), the distributor terminal PT1 determines whether setting information related to the selection of a questioner (that is, display setting of the first question mode screen) is changed by an operation of the distributor TC (St505). The setting information related to the selection of a questioner referred to here includes setting related to a display order for selecting a questioner candidate (for example, in ascending order of interest levels, in descending order of index values, in descending order of total values of sympathy levels and interest levels, and the like), setting of the number of questioner candidates (viewers) displayed on the question mode screen, and the like.

When it is determined in the processing of step St505 that the setting information related to the selection of a questioner is changed (St505, YES), the distributor terminal PT1 transmits the changed setting information to the server S1 (St509).

On the other hand, when it is determined in the processing of step St505 that the setting information related to the selection of a questioner is not changed (St505, NO), the distributor terminal PT1 proceeds the procedure to the processing of step St502 and continues to display the first question mode screen.

The server S1 calculates (evaluates) a display order again based on the changed setting information transmitted from the distributor terminal PT1, records (updates) the changed display order in the index value table TB1 (St510), and transmits information of the calculated (evaluated) display order of a plurality of viewer images to the distributor terminal PT1 (St511).

The distributor terminal PT1 generates the first question mode screen based on the changed setting information related to the selection of a questioner and a new display order of a plurality of viewer images transmitted from the server S 1, and displays the first question mode screen on the display unit 16 (St512).

The distributor terminal PT1 determines whether there is a display switching operation of the distributor TC for switching viewer images of a plurality of viewers displayed on the first question mode screen to viewer images of a plurality of other viewers that are not displayed currently on the first question mode screen (specifically, whether there is an operation of pressing (selecting) a viewer image display switching button BT41 shown in FIG. 14) (St513).

When it is determined in the processing of step St513 that there is the display switching operation (St513, YES), the distributor terminal PT1 proceeds the procedure to the processing of step St512, generates a new first question mode screen including the viewer images of the plurality of the other viewers that are not displayed currently on the first question mode screen based on a latest display order, and displays the new first question mode screen on the display unit 16 (St512). Here, when there is a viewer using a chat function, a raising hand function, a reaction function, or the like of the online video distribution, the distributor terminal PT1 may execute a processing of changing a display order of the corresponding viewer to a highest display order and determine a latest display order. The distributor terminal PT1 selects viewers of a predetermined number (for example, five, seven, and nine) from the top of the latest display order as questioner candidates, and generates and outputs a latest first question mode screen including viewer screens of the selected questioner candidates (viewers) of the predetermined number.

The distributor terminal PT1 determines whether there is an operation of the distributor TC for changing a mode of the online video distribution (St514). When it is determined in the processing of step St514 that there is an operation of the distributor TC for changing the mode of the online video distribution (St514, YES), the distributor terminal PT1 proceeds the procedure to the processing of step St200. On the other hand, when it is determined in the processing of step St514 that there is no operation of the distributor TC for changing the mode of the online video distribution (St514, NO), the distributor terminal PT1 proceeds the procedure to the processing of step St502 and continues to display the first question mode screen.

As described above, the online video distribution support system 100 according to the first embodiment can select viewer images of one or more viewers who are questioner candidates, and present the first question mode screen including the viewer images of the selected viewers to the distributor TC, thereby supporting the distributor TC to select a questioner. The online video distribution support system 100 can select, for example, a viewer having a high interest level in distribution contents, a viewer having a low understanding level, or the like based on the setting information related to the selection of a questioner set by the distributor TC, and thus the distributor TC can more efficiently select a viewer who wants to ask a question.

Here, the index value table TB1 will be described with reference to FIG. 12. FIG. 12 is a diagram showing an example of the index value table TB1. Although an example including viewer face images SCA, SCB, SCC, SCD, SCE, SCF, SCG, SCH, and SCI is shown in the index value table TB1 shown in FIG. 12 in order to make the following description easy to understand, the viewer face images are not essential.

The index value table TB1 is a table for recording index values calculated for each viewer, and records identification information of a viewer (in the example shown in FIG. 12, the name of the viewer and a face image of the viewer) and the calculated (evaluated) index value in association with each other. The index value table TB1 is generated by the processor 31 in the server S1 and is recorded in the memory 32. The index value table TB1 shown in FIG. 12 shows an example in which an interest level, an understanding level, and a sympathy level that are various parameters used for calculating (evaluating) the index value, and a weight coefficient used for calculating (evaluating) the index value are recorded. For example, in the example shown in FIG. 12, a viewer “A” has an interest level “0.81”, an understanding level “0.76”, and a sympathy level “0.52”, a weight coefficient W0 is set when a category of an online video distribution distributed by the distributor TC is a “distribution category A”, and a weight coefficient W1 is set when a category of an online video distribution is a “distribution category B”.

The comparison unit 31B in the server S1 determines and records a display order of viewer images based on calculated various parameters or index values and setting information related to the selection of a questioner (that is, the setting information of the display order) set by the distributor TC. FIG. 12 shows an example in which the setting information related to the selection of a questioner is set such that the lower an index value is, the higher the display order is. In such a case, the comparison unit 31B rearranges the viewers in ascending order of index values and determines a display order. Specifically, in the example shown in FIG. 12, display orders of viewers are determined such that the display order of a viewer “B” having a lowest index value is determined to be “1”, the display order of a viewer “D” having a second lowest index value is determined to be “2”, and the display order of a viewer “F” having a highest index value is determined to be “9”. In this manner, the server S1 can determine display orders of viewer images of a plurality of viewers.

The category of the online video distribution referred to here is a category of distribution contents of the online video distribution, and is set by the distributor TC. The category may be, for example, a lecture subject (Japanese language, mathematics, ethics, history, English, or the like) or a genre (news, movie, game, politics, music, or the like). For example, when distribution contents (for example, a lecture, a class, or the like) are completed by online video distributions over a plurality of times, categories of the online video distributions may be “first time”, “second time”, or the like.

Hereinafter, a specific example of calculating an index indicating a viewing situation of a viewer based on information related to the viewer will be described. The information related to the viewer is, for example, biological information of the viewer, input information to the viewer terminal PS1, and operation information. Details will be described later, and when the index is calculated, biological information of a distributor or input information to the distributor terminal PT1 may be used.

Here, an example of a method of calculating an interest level will be described. The interest level is estimated based on a correlation (that is, similarity) between biological information of the distributor TC and biological information of a viewer, various kinds of input information, biological information, and the like.

For example, the correlation between the biological information of the distributor TC and the biological information of the viewer is calculated (evaluated) using similarity that is calculated based on a distance between a position of the line of sight of the distributor TC and a position of the line of sight of the viewer. In such a case, the processing unit 31A in the server S1 calculates a total gaze time in which the distributor TC continuously looks at each position of the line of sight, and extracts the position of the line of sight having a longest calculated total gaze time. Similarly, the comparison unit 31B calculates, for each viewer, a total gaze time in which each viewer looks at each position of the line of sight based on position information of the line of sight, and extracts the position of the line of sight having a longest calculated total gaze time for each viewer. The comparison unit 31B calculates an interest level by normalizing the distance between the extracted position of the line of sight of the distributor TC and the extracted position of the line of sight of the viewer.

For example, the correlation between the biological information of the distributor TC and the biological information of the viewer is calculated (evaluated) using the similarity between line-of-sight movement line data of the distributor TC and line-of-sight movement line data of the viewer. In such a case, the processing unit 31A in the server S1 generates the line-of-sight movement line data indicating a time series change in positions of the line of sight of the distributor TC by rearranging the positions of the line of sight of the distributor TC in time series based on imaging time associated with the position information of the line of sight of the distributor TC. Similarly, the processing unit 31A generates, for each viewer, the line-of-sight movement line data indicating a time series change in positions of the line of sight of a viewer by rearranging the positions of the line of sight of the viewer in time series based on imaging time associated with position information of the line of sight of the viewer. The comparison unit 31B uses the generated line-of-sight movement line data of the distributor TC and the generated line-of-sight movement line data of the viewer to calculate an average distance (similarity) between positions of the line of sight in two pieces of line-of-sight nmovement line data for each predetermined time. The comparison unit 31B calculates an interest level by normalizing the average distance between the extracted position of the line of sight of the distributor TC and the extracted position of the line of sight of the viewer.

For example, the correlation between the biological information of the distributor TC and the biological information of the viewer is calculated (evaluated) using the similarity between a line-of-sight heat map of the distributor TC and a line-of-sight heat map of the viewer. In such a case, the processing unit 31A in the server S1 generates the line-of-sight heat map of the distributor TC in which a position frequently viewed by the distributor TC is mapped based on accumulated information of positions of the line of sight of the distributor TC and a gaze time that is associated with the information of the positions of the line of sight and in which the distributor TC continuously looks at the positions of the line of sight. Similarly, the processing unit 31A generates the line-of-sight heat map for each viewer in which a position frequently viewed by a viewer is mapped based on accumulated information of positions of the line of sight of each viewer and a gaze time that is associated with the information of the positions of the line of sight and in which the viewer continuously looks at the positions of the line of sight. The comparison unit 31B calculates a color difference for each pixel using the generated line-of-sight heat map of the distributor TC and the generated line-of-sight heat map of the viewer, normalizes the calculated color difference, and calculates a correlation (similarity) between the line-of-sight heat map of the distributor TC and the line-of-sight heat map of the viewer. The comparison unit 31B calculates an interest level by normalizing the correlation (similarity) between the extracted line-of-sight heat map of the distributor TC and the extracted line-of-sight heat map of the viewer.

The processing unit 31A may execute weighting on the gaze time for each position of the line of sight. For example, the processing unit 31A may use a weight function that decreases the gaze time of the position of the line of sight used to generate the line-of-sight heat map accompanying with an increase in an elapsed time from when the position of the line of sight is viewed to a current time to calculate the position of the line of sight having a longest total gaze time or a gaze time for each position of the line of sight used to generate the line-of-sight heat map. The weight function used here may be a function that decreases the gaze time accompanying with an increase in the elapsed time. For example, the weight function is any one of a linear function, a cumulative distribution function, a sigmoid function, or the like.

For example, the server S1 estimates a change in a feeling of a viewer by using various kinds of input information and biological information of each viewer, estimates a feeling of a viewer by analyzing input contents (for example, input characters, information related to a feeling acquired by analyzing an image, or the like), or estimates a change in a feeling of a viewer based on a change in vital information (for example, a change in a heartbeat, a change in respiration, or the like). The server S1 calculates (evaluates) an interest level of each viewer in distribution contents based on the estimation result.

For example, the input information (or operation information) of each viewer used to calculate the interest level may use state information of a video distribution screen window. In this case, the server S1 receives the state information of the video distribution screen window (for example, the shared material display region SC21 shown in FIG. 4) displayed on the display unit 26 from each viewer terminal PS1, and calculates (evaluates) an interest level of each viewer in the distribution contents based on the state information. As a specific example, the server S1 estimates a time period of a viewing state and a time period of a non-viewing state of a viewer based on the state information associated with time information, and calculates the interest level of the viewer based on a ratio of the time period of the viewing state to the time period of the non-viewing state. That is, the interest level is calculated to have a larger value as the time period of the viewing state is longer, and the interest level is calculated to have a smaller value as the time period of the non-viewing state is longer. When the state information indicates a state in which the video distribution screen window is maximized on the display unit 26 or a state in which the video distribution screen window is opened on the top on the display unit 26, the server S1 estimates that a viewer is in a viewing state in this time period. On the other hand, when the state information indicates a state in which the video distribution screen window is minimized on the display unit 26 or a state in which another window is opened on top of the video distribution screen window on the display unit 26, the server S1 estimates that a viewer is in a non-viewing state in this time period.

As described above, for example, an interest level of a viewer can be calculated using one or both of various kinds of input information and biological information of a viewer. As described above, when calculating the interest level of the viewer, biological information of a distributor may be used. The calculation of the interest level is not limited to the example described above, and other methods may be used.

Next, an example of a method of calculating an understanding level will be described. The understanding level is calculated for each viewer based on a score (a scoring result) of a test, a pop quiz, or the like distributed by the distributor TC. The test, the pop quiz, and the like for calculating the understanding level may be performed during an online video distribution. The server S1 calculates an understanding level (a score) for each viewer based on answer information set by the distributor TC in advance and input information of each viewer (that is, answer information to the test and the pop quiz). The test, the pop quiz, and the like referred to here may be a test, a pop quiz, and the like performed during an online video distribution distributed in the past. In such a case, the server S1 extracts results (scores) of all or a part of the test, the pop quiz, and the like for each viewer, and calculates an understanding level for each viewer based on an average value or a total value of the extracted results (scores) of the test, the pop quiz, and the like, or a value obtained by normalizing the total value with a value of a full score of the test, the pop quiz, and the like.

Next, an example of a method of calculating a sympathy level will be described. The sympathy level is calculated for each viewer based on, for example, a predetermined number of facial expressions (for example, the number of smiling faces) of a viewer during an online video distribution, a predetermined number of motions (for example, the number of nodding motions) of the viewer, or a stress level calculated based on biological information (for example, heartbeat) of the viewer. In such a case, the server S1 calculates the sympathy level to be high as the predetermined number of facial expressions and the predetermined number of motions are large, or calculates the sympathy level to be low as the stress level is high. The server S1 may measure a time in which it is determined that a viewer feels stress during an online video distribution based on the calculated biological information (for example, heartbeat) of the viewer, and calculate the sympathy level based on a total time in which the stress level of the viewer is equal to or less than a predetermined value. In such a case, the server S1 calculates the sympathy level to be high as the total time in which the stress level is equal to or less than the predetermined value is long. Further, the server S1 may generate feeling time series data indicating a temporal change in a stress level of the distributor TC based on the biological information of the distributor TC and feeling time series data indicating a temporal change in a stress level of a viewer, and calculate the sympathy level based on a correlation (similarity) between the feeling time series data of the distributor TC and the feeling time series data of the viewer. In such a case, the server S1 calculates the sympathy level of a viewer to be high as the similarity between the feeling time series data of the distributor TC and the feeling time series data of the viewer is high.

Screen examples of the question mode screens SC3 and SC4 (that is, the first question mode screen) displayed on the distributor terminal PT1 in the question mode will be described with reference to FIGS. 13 and 14. FIG. 13 is a view showing an example of the question mode screen SC3 displayed on the distributor terminal PT1. FIG. 14 is a view showing an example of the question mode screen SC4 displayed on the distributor terminal PT1. It is needless to say that question mode screens SC3 and SC4 shown in FIGS. 13 and 14 are merely examples, and the present invention is not limited thereto.

The question mode screen SC3 is generated by the distributor terminal PT1 or the server S1, and is displayed on the display unit 16 of the distributor terminal PT1. The question mode screen SC3 shown in FIG. 13 is generated such that the entire region of the question mode screen SC3 serves as a viewer image display region, and includes a distributor image FC20 and viewer images FC11, FC12, FC13, FC14, FC15, FC16, FC18, and FC19 of eight viewers rearranged by a method designated by the setting information related to the selection of a questioner. The number of viewer images (that is, the number of viewers) displayed in the viewer image display region of the question mode screen SC3 is preferably larger than the number of viewer images (that is, the number of viewers) displayed on the video distribution screen SC1 (see FIG. 3) displayed in the lecture mode, and the present invention is not limited thereto. Accordingly, the distributor TC can select a questioner from a larger number of questioner candidates on the question mode screen SC3.

When the number of viewer images displayed on the question mode screen SC3 exceeds the number of viewers that can be displayed on the question mode screen SC3, viewer images of a predetermined number of viewers selected by a method designated by the setting information related to the selection of a questioner may be rearranged and displayed using the method designated by the setting information related to the selection of a questioner. On the other hand, when the number of viewers who view an online video distribution is equal to or less than the number of viewers that can be displayed on the question mode screen SC3, viewer images included in the question mode screen SC3 may be rearranged and displayed using the method designated by the setting information related to the selection of a questioner.

The distributor terminal PT1 or the server S1 may specify a viewer who is uttering (asking a question) among a plurality of viewers displayed on the question mode screen SC3 based on voice data (an example of utterance voice data) of a viewer transmitted from each of the plurality of viewer terminals PS1. In such a case, the distributor terminal PT1 or the server S1 may superimpose a frame line on a viewer image corresponding to the viewer who is uttering (asking a question) and display the viewer image in an emphasized manner. For example, in the example shown in FIG. 13, when the distributor terminal PT1 or the server S1 determines that a viewer corresponding to the viewer image FC18 is uttering (asking a question), the distributor terminal PT1 or the server S1 generates the question mode screen SC3 on which a frame line is superimposed on the viewer image FC18. Accordingly, the distributor TC can know at a glance the viewer who is uttering (asking a question) among a plurality of viewers displayed on the question mode screen SC3.

Further, the distributor terminal PT1 or the server S1 may determine an arrangement, an arrangement order, and the like of viewer images of a plurality of viewers displayed on the question mode screen SC3 based on various parameters or index values of the plurality of viewers. For example, when a questioner candidate is selected in descending order of interest levels of the viewers, the distributor terminal PT1 or the server S1 determines a display order of a plurality of viewers in descending order of interest levels of the plurality of viewers. The distributor terminal PT1 or the server S1 determines an arrangement, an arrangement order, and the like of viewer images of the plurality of viewers displayed on the question mode screen SC3 based on the determined display order. For example, the distributor terminal PT1 or the server S1 may generate the question mode screen SC3 on which viewer images are arranged such that the interest levels of the viewers decrease from the upper left to the lower right of the question mode screen SC3 (that is, the display order decreases). Accordingly, the distributor TC can intuitively know an interest level of each of the plurality of viewers displayed on the question mode screen SC3.

The question mode screen SC4 is generated by the distributor terminal PT1 or the server S1 and displayed on the display unit 16 of the distributor terminal PT1. The question mode screen SC4 shown in FIG. 14 includes a shared material display region SC41, a viewer image display region SC42 in which viewer images of viewers who are selected as questioners are displayed, a distributor image display region SC44 in which a distributor image is displayed, and a viewer image display switching button BT41. The viewer image display region SC42 on the question mode screen SC4 displays viewer images FC11, FC12, FC13, FC14, and FC15 of the rearranged five viewers that are selected by a method designated by the setting information related to the selection of a questioner. The distributor image display region SC44 may be movable to any position on the question mode screen SC4 based on an operation of the distributor TC (for example, a drag operation).

When the viewer image display switching button BT41 is pressed (selected) by an operation of the distributor TC, the distributor terminal PT1 or the server S1 switches viewer images of questioner candidates (viewers) who are currently displayed on the question mode screen to viewer images of questioner candidates (viewers) who are not currently displayed on the question mode screen. For example, in the example shown in FIG. 14, when the viewer image display switching button BT41 is pressed (selected) by an operation of the distributor TC, the distributor terminal PT1 or the server S1 switches the viewer images FC11, FC12, FC13, FC14, and FC15 of the questioner candidates (viewers) who are currently displayed on the question mode screen to the viewer images FC16, FC17, FC18, and FC19 of questioner candidates (viewers) who are not currently displayed on the question mode screen.

Each of the viewer images of the questioner candidates (viewers) to be displayed subsequently may be determined based on a display order recorded in the index value table TB1, or may be selected at random. When the viewer image display switching button BT41 is pressed (selected) again by an operation of the distributor TC, the distributor terminal PT1 or the server S1 selects viewer images of questioner candidates (viewers) to be displayed on the question mode screen from viewer images of questioner candidates (viewers) who have not been displayed on the question mode screen.

When the number of viewers who view an online video distribution exceeds the number of viewers that can be displayed on the question mode screens SC3 and SC4, each of the question mode screens SC3 and SC4 may further include a viewer image display switching button (for example, the viewer image display switching button BT41 shown in FIG. 14). When the viewer image display switching button is pressed (selected) by the distributor TC, the distributor terminal PT1 generates and displays a question mode screen on which viewer images of viewers who are not currently displayed on the question mode screen is included in the viewer image display region. The generation of the question mode screen including the viewer images of the viewers who are not currently displayed on the question mode screen may be executed by the server S1.

Further, the distributor terminal PT1 or the server S1 may superimpose a thick frame on a viewer image of a viewer (a questioner) who is uttering and display the viewer image (for example, the viewer image FC18 shown in FIG. 13) in an emphasized manner on each of the question mode screens SC3 and SC4, may display the viewer image of a viewer (a questioner) who is uttering in a background color different from a background color of viewer images of other viewers who are not uttering, or may display the viewer image of a viewer (a questioner) who is uttering in a size larger than a size of viewer images of other viewers who are not uttering. The distributor terminal PT1 or the server S1 may replace a viewer image corresponding to a questioner with a viewer image that is not currently displayed on the question mode screens SC3 and SC4 at a timing when the questioner finishes uttering (asking a question). The timing at which the questioner finishes uttering (asking a question) may be determined by the distributor TC or may be determined by the distributor terminal PT1 or the server S1. The distributor terminal PT1 or the server S1 may display a viewer image in a manner of superimposing a number or a symbol indicating an interest level of a viewer on a viewer image of each of a plurality of viewers.

Screen examples of the question mode screens SC5 and SC6 (that is, the second question mode screen) displayed on each of the viewer terminals PS1 in the question mode will be described with reference to FIGS. 15 and 16. FIG. 15 is a view showing an example of the question mode screen SC5 displayed on each of the viewer terminals PS1. FIG. 16 is a view showing an example of the question mode screen SC6 displayed on each of the viewer terminals PS1. It is needless to say that the question mode screens SC5 and SC6 shown in FIGS. 15 and 16 are merely examples, and the present invention is not limited thereto.

The question mode screen SC5 is generated by the server S1 and displayed on the display unit 26 of each of the viewer terminals PS1. The question mode screen SC5 shown in FIG. 15 includes a viewer image display region SC52 in which viewer images of a plurality of viewers are displayed, and a distributor image display region SC54 in which a distributor image is displayed.

The viewer images of a plurality of viewers displayed in the viewer image display region SC52 of the question mode screen SC5 may not match the viewer images of the plurality of viewers included in the question mode screens SC3 and SC4 displayed on the distributor terminal PT1. Accordingly, when the viewer images displayed on the question mode screen displayed on the distributor terminal PT1 and the viewer images displayed on the question mode screen displayed on each of the plurality of viewer terminals PS1 are the same, the server S1 can more effectively prevent an increase in parameters such as an interest level and a sympathy level of a viewer based on biological information of a viewer displayed on the question mode screen (that is, a temporary increase in the interest level, a temporary increase in the sympathy level) that is generated due to a viewer corresponding to a viewer image displayed on the question mode screen being aware that the viewer is being viewed by the distributor TC through the question mode screen (the line of sight of the distributor TC is directed at the viewer).

The question mode screen SC5 shown in FIG. 15 shows an example in which, for example, viewer images FC11, FC12, FC13, FC14, FC15, FC16, FC18, and FC19 of six viewers selected at random among a plurality of viewers are displayed in the viewer image display region SC52. The distributor image display region SC54 may be movable to any position on the question mode screen SC5 based on an operation of a viewer (for example, a drag operation).

The question mode screen SC6 is generated by the server S1 and displayed on the display unit 26 of each of the viewer terminals PS1. The question mode screen SC6 shown in FIG. 15 includes a shared material display region SC61, a viewer image display region SC62 in which viewer images of a plurality of viewers are displayed, and a distributor image display region SC64 in which a distributor image is displayed.

The viewer images of the plurality of viewers displayed in the viewer image display region SC62 of the question mode screen SC6 may not match the viewer images of the plurality of viewers included in the question mode screens SC3 and SC4 displayed on the distributor terminal PT1.

The question mode screen SC6 shown in FIG. 16 shows an example in which, for example, viewer images FC11, FC12, FC13, FC14, FC15, FC16, FC18, and FC19 of six viewers selected at random among a plurality of viewers are displayed in the viewer image display region SC62. The distributor image display region SC64 may be movable to any position on the question mode screen SC6 based on an operation of a viewer (for example, a drag operation).

Screen examples of the question mode screens SC7 and SC8 displayed on the distributor terminal PT1 and each of the viewer terminals PS1 in the question mode will be described with reference to FIGS. 17 and 18. FIG. 17 is a view showing an example of the question mode screen SC7 displayed on each of the viewer terminals PS1. FIG. 18 is a view showing an example of the question mode screen SC8 displayed on each of the viewer terminals PS1. It is needless to say that the question mode screens SC7 and SC8 shown in FIGS. 17 and 18 are merely examples, and the present invention is not limited thereto.

The question mode screen SC7 is generated by the distributor terminal PT1 or the server S1, and is displayed on the display unit 16 of the distributor terminal PT1 and the display unit 26 of each of the viewer terminals PS1. The question mode screen SC7 shown in FIG. 17 includes a viewer image display region SC72 in which viewer images of a plurality of viewers are displayed, a distributor image display region SC74 in which a distributor image is displayed, and a questioner image display region SC75 in which a viewer image of a viewer who is a questioner (in the example shown in FIG. 17, a viewer image of a viewer “G”) is displayed. The viewer images of a plurality of viewers displayed in the viewer image display region SC72 of the question mode screen SC7 may not match the viewer images of the plurality of viewers included in the question mode screen displayed on the distributor terminal PT1 and the viewer images of the plurality of viewers included in the question mode screen displayed on each of the plurality of viewer terminals PS1. The question mode screen SC7 displays, for example, viewer images FC11, FC13, FC15, FC16, and FC17 of five viewers who are selected at random among the plurality of viewers. The distributor image display region SC74 may be movable to any position on the question mode screen SC7 based on an operation of a viewer (for example, a drag operation).

The question mode screen SC8 is generated by the distributor terminal PT1 or the server S1, and is displayed on the display unit 16 of the distributor terminal PT1 and the display unit 26 of each of the viewer terminals PS1. The question mode screen SC8 shown in FIG. 18 includes a shared material display region SC81, a viewer image display region SC82 in which viewer images of a plurality of viewers are displayed, and a questioner image display region SC85 in which a viewer image of a viewer who is a questioner (in the example shown in FIG. 18, a viewer image of a viewer “G”) is displayed. The viewer images of a plurality of viewers displayed in the viewer image display region SC82 of the question mode screen SC8 may not match the viewer images of the plurality of viewers included in the question mode screen displayed on the distributor terminal PT1 and the viewer images of the plurality of viewers included in the question mode screen displayed on each of the plurality of viewer terminals PS1. The question mode screen SC8 displays, for example, viewer images FC11, FC13, FC15, FC16, and FC17 of five viewers who are selected at random among the plurality of viewers.

Examples of the preview screens SC9 and SC10 displayed on the distributor terminal PT1 in the group discussion mode will be described with reference to FIGS. 19 and 20. FIG. 19 is a view showing an example of the preview screen SC9. FIG. 20 is a view showing an example of the preview screen SC10. It is needless to say that the preview screens SC9 and SC10 shown in FIGS. 19 and 20 are merely examples, and the present invention is not limited thereto.

The preview screen SC9 is a screen showing a grouping result of grouping a plurality of viewers into two or more groups based on the setting information related to a grouping method set by the distributor TC, is generated by the distributor terminal PT1 or the server, and is displayed on the display unit 16 of the distributor terminal PT1.

In the setting information related to the grouping method shown in FIG. 19, for example, an index value is an interest level, and an algorithm for grouping the viewers is set such that average interest levels of the viewers grouped into two groups are substantially the same (specifically, the average interest levels are within a predetermined difference (for example, 0.50, 0.10, or the like)). In such a case, the distributor terminal PT1 or the server S1 groups nine viewers based on the index values (interest levels) of the viewers such that the average interest levels of the plurality of viewers grouped into a first group “group A” and a second group “group B” are substantially the same (that is, within a predetermined difference). The average interest level of the “group A” shown in FIG. 19 is 0.58. The average interest level of the “group B” is 0.58. The grouping method is not limited to the above-described method, and other methods may be used. For example, other methods may use an algorithm for grouping viewers such that a difference in the number of viewers grouped into two groups is minimized and a difference in the average interest levels is minimized. In this case, the distributor terminal PT1 or the server S1 can group a plurality of viewers such that the number of viewers in each group is substantially equal even when interest levels of the viewers greatly vary from one another.

Based on the grouping result, the distributor terminal PT1 or the server S1 generates the preview screen SC9 including viewer images of five viewers grouped into the “group A” and viewer images of four viewers grouped into the “group B”. At this time, the distributor terminal PT1 or the server S1 may display an average value of the interest levels of the plurality of viewers displayed in the “group A” on the preview screen SC9 in a manner of being superimposed on the display of the “group A” on the preview screen SC9. The distributor terminal PT1 or the server S1 may display an average value of the interest levels of the plurality of viewers displayed in the “group B” on the preview screen SC9 in a manner of being superimposed on the display of the “group B” on the preview screen SC9.

The setting information related to the grouping method shown in FIG. 20 shows an example in which an index value is an interest level, and an algorithm for grouping viewers is set such that index values (interest levels) are in descending order. In such a case, the distributor terminal PT1 or the server S1 rearranges a sequence of each of a plurality of viewers such that index values (interest levels) are in descending order based on the index value (the interest level) of each of the plurality of viewers. The distributor terminal PT1 or the server S1 groups the first to fifth viewers into the first group “group A” and groups the sixth to ninth viewers into the second group “group B” based on the sequence of the rearranged viewers. The sequence referred to here may be calculated as a display order. The distributor terminal PT1 or the server S1 may record the sequence of the rearranged viewers in a memory in association with identification information of the viewers.

Based on the grouping result, the distributor terminal PT1 or the server S1 generates the preview screen SC10 including viewer images of the five viewers grouped into the “group A” and viewer images of the four viewers grouped into the “group B”. At this time, the distributor terminal PT1 or the server S1 may display an average value of the interest levels of the five viewers grouped into the “group A” on the preview screen SC10 in a manner of being superimposed in a region of the “group A” on the preview screen SC10. The distributor terminal PT1 or the server S1 may display an average value of the interest levels of the four viewers grouped into the “group B” on the preview screen SC10 in a manner of being superimposed in a region of the “group B” on the preview screen SC10.

### Second Embodiment

In the online video distribution support system 100 according to the first embodiment described above, an example is described in which the server S1 calculates (evaluates) various parameters or index values of viewers and determines a display order. In an online video distribution support system 100A according to the second embodiment, an example will be described in which a distributor terminal PT1A calculates (evaluates) various parameters or index values of viewers and determines a display order.

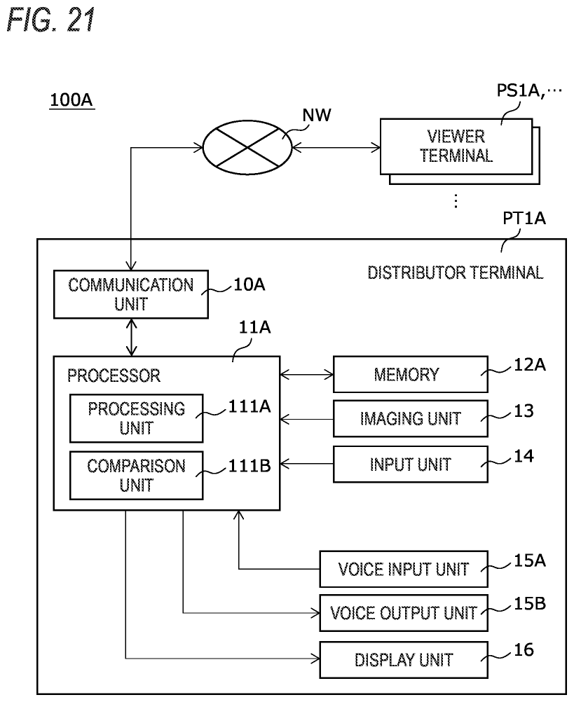

An internal configuration of the online video distribution support system 100A according to the second embodiment will be described with reference to FIG. 21. FIG. 21 is a block diagram showing an example of the internal configuration of the online video distribution support system 100A according to the second embodiment. The internal configuration of the online video distribution support system 100A according to the second embodiment shown in FIG. 21 is the same as the internal configuration of the online video distribution support system 100, the distributor terminal PT1, and each of the plurality of viewer terminals PS1 according to the first embodiment, the same components are denoted by the same reference numerals, and thus description thereof will be omitted.

Functions executed by the processing unit 31A and the comparison unit 31B in the server S1 according to the first embodiment are respectively executed by a processing unit 111A and a comparison unit 111B in the distributor terminal PT1A in the online video distribution support system 100A according to the second embodiment. Specifically, the distributor terminal PT1A according to the second embodiment executes the processings executed by the server S1 and the distributor terminal PT1 in the operation procedure examples shown in FIGS. 5 to 11.

First, the distributor terminal PT1A according to the second embodiment will be described. The distributor terminal PT1A is connected to each of a plurality of viewer terminals PS1A via the network NW so that the distributor terminal PT1A can execute wireless communication with each of the plurality of viewer terminals PS1A. The processor 11A of the distributor terminal PT1A extracts biological information of each viewer based on viewer images, voice data of viewers, input operation information, and the like transmitted from each of the plurality of viewer terminals PS1A, and records the extracted biological information of each viewer. The distributor terminal PT1A calculates (evaluates) various parameters such as an interest level, an understanding level, and a sympathy level for each viewer based on the recorded biological information. The distributor terminal PT1A calculates an index value based on a calculation (evaluation) result of the various parameters and various kinds of setting information (setting information related to a grouping method and setting information related to the selection of a questioner candidate). Based on the calculated index value, the distributor terminal PT1A sorts a plurality of viewers who view an online video distribution into a plurality of groups, or selects a candidate of a viewer (hereinafter, referred to as a “questioner”) who makes a call with (for example, asks a question to) the distributor TC among the plurality of viewers.

A communication unit 10A transmits data to and receives data from each of the plurality of viewer terminals PS1A via the network NW. The communication unit 10A outputs, to the processor 31, various control commands, various kinds of setting information, data of a shared material, viewer images, biological information of viewers, and the like that are transmitted from each of the viewer terminals PS1A. The communication unit 10A transmits various screens output from the processor 11A to corresponding viewer terminals PS1A.

The processor 11A implements functions of units by referring to a program and data stored in a memory 12A and executing the program. The units referred to here are the processing unit 111A and the comparison unit 111B. For example, the processor 11A executes a function of calculating an index value, a function of grouping viewers, a function of selecting a questioner, a function of generating various screens, and the like based on the biological information of a viewer transmitted from each of the viewer terminals PS1A.

The processing unit 111A executes the same processing as the processing unit 31A of the server S1 and the processor 11 of the distributor terminal PT1 according to the first embodiment.

The comparison unit 111B executes the same processing as the comparison unit 31B of the server S1 according to the first embodiment.

The memory 12A further stores identification information of each of a plurality of viewers, the index value table TB1 (see FIG. 12), and the like. In addition, the memory 12A stores a learning model and the like used in the CNN analysis processing.

As described above, each of the online video distribution support systems 100 and 100A according to the first embodiment and the second embodiment includes one or more computers (for example, the distributor terminal PT1, the server S1, and the like). An online video distribution support method is a method to be executed by the computer that is communicably connected to a plurality of viewer terminals PS1, PS1A respectively used by an N number of viewers (N is an integer equal to or larger than 2) who view an online video. The online video distribution support method includes acquiring viewer information related to a viewer in an online video distribution, calculating an index value (an example of an index) indicating a viewing situation of a viewer in the online video distribution based on the acquired viewer information, and selecting an M number of viewers (M is an integer satisfying 1≤M<N) from the N number of viewers based on the calculated index value and outputting information related to the M number of viewers.

Accordingly, the online video distribution support systems 100 and 100A according to the first embodiment and the second embodiment can select two or more questioner candidates (viewers) from all viewers and present the selected questioner candidates to the distributor TC. Therefore, the online video distribution support systems 100 and 100A according to the first embodiment and the second embodiment can present the M number of viewers selected from the N number of viewers, and thus can support the distributor TC to select (name) any one questioner. Even when the distributor TC does not know a state of each of the N number of viewers (specifically, an interest level, an understanding level, a sympathy level, and the like), the distributor TC can select any one questioner from the M number of viewers selected on based on viewer states indicated by the calculated parameters or index values, and thus the distributor TC can efficiently select (name) a questioner.

As described above, the online video distribution support systems 100 and 100A according to the first embodiment and the second embodiment generate and output the question mode screens SC3 and SC4 (screen examples) including viewer images of the selected M number of viewers. Accordingly, the online video distribution support systems 100 and 100A according to the first embodiment and the second embodiment can generate the question mode screens SC3 and SC4 (see FIGS. 13 and 14) including viewer images of two or more questioner candidates (viewers) selected from all viewers, output the question mode screens SC3 and SC4 to the display unit 16 of the distributor terminal PT1, and support the distributor TC to select (name) any one questioner. The distributor TC can select (name) any one questioner while viewing viewer images of the N number of viewers displayed on the question mode screens SC3 and SC4, and can efficiently select (name) the questioner.

As described above, the online video distribution support systems 100 and 100A according to the first embodiment and second embodiment determine a display order of the viewer images of the M number of viewers based on parameters or index values, and generate and output a question mode screen on which the viewer images of the M number of viewers are rearranged based on the determined display order. Accordingly, the online video distribution support systems 100 and 100A according to the first embodiment and the second embodiment generate the question mode screens SC3 and SC4 (see FIGS. 13 and 14) on which two or more questioner candidates (viewers) are rearranged based on the display order (a priority order) of the questioner candidates, thereby generating the question mode screens SC3 and SC4 on which the distributor TC can confirm the display order (the priority order) of each questioner candidate at a glance. Therefore, the online video distribution support systems 100 and 100A can support the distributor TC to select (name) one questioner from a plurality of questioner candidates based on the arrangement of the viewer images on the question mode screens SC3 and SC4. Since the distributor TC can intuitively know states (parameters or index values) of the viewers based on the arrangement of the viewer images of the N number of viewers displayed on the question mode screens SC3 and SC4, the distributor TC can efficiently select (name) a questioner.

As described above, the online video distribution support systems 100 and 100A according to the first embodiment and the second embodiment generate and output the question mode screen SC3 on which a frame line is superimposed on a viewer image (for example, the viewer image FC18 on the question mode screen SC3 shown in FIG. 13) of any viewer selected by the distributor TC who distributes an online video among the M number of viewers. Accordingly, the online video distribution support systems 100 and 100A according to the first embodiment and the second embodiment can present, to the distributor TC, the question mode screen SC3 on which the questioner (viewer) selected by the distributor TC is displayed in a more emphasized manner. Therefore, the distributor TC can know the selected (named) viewer at a glance.

As described above, the online video distribution support systems 100 and 100A according to the first embodiment and the second embodiment generate and output the question mode screens SC7 and SC8 (screen examples) on which a viewer image of any viewer selected by the distributor TC who distributes an online video among the M number of viewers is displayed in a size larger than a size of a viewer image of a viewer who is not selected. Accordingly, the online video distribution support systems 100 and 100A according to the first embodiment and the second embodiment can present, to the distributor TC, the question mode screens SC7 and SC8 on which the questioner (viewer) selected by the distributor TC is displayed in a more emphasized manner. Therefore, the distributor TC can know the selected (named) viewer at a glance.

As described above, the online video distribution support systems 100 and 100A according to the first embodiment and the second embodiment acquire voice data (an example of utterance voice data) of a viewer, and generate and output, based on the voice data, the question mode screen SC3 on which a frame line is superimposed on a viewer image of a viewer determined as a viewer who is uttering (that is, asking a question) among the viewer images of the M questioner candidates. Accordingly, the online video distribution support systems 100 and 100A according to the first embodiment and the second embodiment can display a questioner (a viewer) selected by the distributor TC among viewer images of a plurality of viewers included in the question mode screen SC3 in a more emphasized manner. Therefore, the distributor TC can know the selected (named) viewer at a glance.

As described above, the online video distribution support systems 100 and 100A according to the first embodiment and the second embodiment acquire utterance voice data of a viewer, and generate and output, based on the utterance voice data, a question mode screen on which a viewer image of a viewer determined to be a viewer who is uttering among the viewer images of the M questioner candidates is displayed in a size larger than a size of a viewer image of a viewer who is not selected. Accordingly, the online video distribution support systems 100 and 100A according to the first embodiment and the second embodiment can display a questioner (a viewer) selected by the distributor TC among viewer images of a plurality of viewers included in the question mode screens SC7 and SC8 in a more emphasized manner. Therefore, the distributor TC can know the selected (named) viewer at a glance.

As described above, a question mode screen in each of the online video distribution support systems 100 and 100A according to the first embodiment and the second embodiment includes the viewer image display switching button BT41 (an example of a switching button) for switching the viewer images of the M number of viewers. When it is determined that the viewer image display switching button BT41 is pressed by the distributor TC who distributes an online video, a K number of viewers (K: 1≤K≤M) are selected from viewers who are not included in the question mode screen SC4 based on the parameters or the index values, and the question mode screen SC4 including the viewer images of the selected K number of viewers is generated and output. Accordingly, the online video distribution support systems 100 and 100A according to the first embodiment and the second embodiment can switch viewer images of viewers included in the question mode screen SC4 to viewer images of other viewers that are not currently displayed.

As described above, in the online video distribution support systems 100 and 100A according to the first embodiment and the second embodiment, when it is determined that the viewer image display switching button BT41 (an example of the switching button) is pressed by the distributor TC, the parameters or the index values of the M number of viewers are reset, and the K number of viewers are selected based on the reset parameters or index values of the M number of viewers. Accordingly, the online video distribution support systems 100 and 100A according to the first embodiment and the second embodiment can efficiently prevent the same viewer from being repeatedly displayed on the question mode screens SC3 and SC4.

As described above, in the online video distribution support systems 100 and 100A according to the first embodiment and the second embodiment, the parameter or the index value is an interest level of a viewer calculated using viewer information and biological information of the distributor TC who distributes an online video. Accordingly, the online video distribution support systems 100 and 100A according to the first embodiment and the second embodiment can select each of a plurality of questioner candidates based on an interest level (a state) of a viewer.

As described above, the online video distribution support systems 100 and 100A according to the first embodiment and the second embodiment distribute questions (for example, a small test, understanding level check data, and the like) related to distribution contents of an online video, acquire answers (for example, various kinds of input information) of viewers to the distributed questions, calculate understanding levels of the N number of viewers based on correctness of the answers, and calculate index values based on the calculated understanding levels. Accordingly, the online video distribution support systems 100 and 100A according to the first embodiment and the second embodiment can select each of a plurality of questioner candidates based on an understanding level (a state) of a viewer.

As described above, the server S1 according to the first embodiment includes one or more computers (for example, the server S1), and includes the communication unit 30 (an example of an acquisition unit) that acquires viewer information related to N (N is an integer equal to or larger than 2) viewers who view an online video, the comparison unit 31B (an example of a calculation unit) that calculates an index value (an example of an index) indicating a viewing situation of the viewers during an online video distribution based on the viewer information, and the processing unit 31A (an example of an output unit) that selects and outputs each of M (M is an integer satisfying 1≤M<N) viewers from the N number of viewers based on the index value calculated by the comparison unit 31B.

Accordingly, the server S1 according to the first embodiment can present each of the M number of viewers selected from the N number of viewers, and thus can support the distributor TC to select (name) any one questioner. Even when the distributor TC does not know a state of each of the N number of viewers (specifically, an interest level, an understanding level, a sympathy level, and the like), the distributor TC can select (name) any one questioner from the M number of viewers selected based on the states of the viewers indicated by the calculated parameters or index values, and thus the distributor TC can efficiently select (name) a questioner.

As described above, each of the online video distribution support systems 100 and 100A according to the first embodiment and the second embodiment includes one or more computers (for example, the distributor terminal PT1, the server S1, and the like). An online video distribution support method is a method to be executed by the computer that is communicably connected to a plurality of viewer terminals PS1, PS1A respectively used by N (N is an integer equal to or larger than 2) viewers who view an online video. The online video distribution support method includes acquiring viewer information related to a viewer in an online video distribution, calculating an index value (an example of an index) indicating a viewing situation of a viewer who views an online video based on the acquired viewer information, calculating an index value indicating a viewing situation of a viewer in the online video distribution based on the index value and setting information (an example of a grouping condition) related to a grouping method that is set by the distributor TC who distributes an online video and is used for grouping the N number of viewers into two or more groups, and grouping the N number of viewers into two or more groups based on the setting information related to the grouping method and parameters or index values and outputting the grouping information.

Accordingly, the online video distribution support systems 100 and 100A according to the first embodiment and the second embodiment can group the N number of viewers into two or more groups based on states (parameters or index values) of the viewers. Therefore, even when the distributor TC does not know a states of each of the N number of viewers (for example, an interest level, an understanding level, a sympathy level, or the like), the distributor TC can more efficiently group the N number of viewers by setting the setting information related to the grouping method.

As described above, the online video distribution support systems 100 and 100A according to the first embodiment and the second embodiment acquire viewer images (image examples) of the N number of viewers, and generate and output the preview screens SC9 and SC10 (screen examples) on which viewer images of the N number of viewers are grouped into two or more groups. Accordingly, the online video distribution support systems 100 and 100A according to the first embodiment and the second embodiment can visualize information related to whether the viewers are grouped as the distributor TC desired and present the information to the distributor TC.

As described above, the online video distribution support systems 100 and 100A according to the first embodiment and the second embodiment generate and output information related to a sub venue (an example of a distribution venue) of an online video in which viewers grouped into each group can participate. Accordingly, the online video distribution support systems 100 and 100A according to the first embodiment and the second embodiment can create a sub venue in which a group discussion, a group work, or the like can be performed for each group, and sort (move) grouped viewers to a sub venue corresponding to each group.

As described above, the setting information related to the grouping method used in the online video distribution support systems 100 and 100A according to the first embodiment and the second embodiment includes a date and time condition (for example, a condition related to a target period) in which viewer information used to calculate the parameters or the index values is acquired. When it is determined that the biological information of the distributor TC and the viewer information that satisfy the date and time condition are present, the parameters or the index values of each viewer are calculated based on the biological information of the distributor TC and the viewer information that satisfy the date and time condition. Accordingly, the online video distribution support systems 100 and 100A according to the first embodiment and the second embodiment can calculate an index value including various parameters calculated in a past online video distribution, or set a change amount of an interest level, an understanding level, or a sympathy level of each viewer based on the various parameters calculated in the past as an index value. For example, the online video distribution support systems 100 and 100A calculate the index value or set the index value periodically such as an online lecture (class) performed several times, or when an online video distribution related to distribution contents is performed.

As described above, when the online video distribution support systems 100 and 100A according to the first embodiment and the second embodiment determine that the setting information related to the grouping method is changed by an operation of the distributor TC, the online video distribution support systems 100 and 100A re-group the N number of viewers into two or more groups based on the changed setting information related to the grouping method, and output the re-grouping information. Accordingly, the online video distribution support systems 100 and 100A according to the first embodiment and the second embodiment can more adaptively group viewers in a manner desired by the distributor TC.

As described above, the online video distribution support systems 100 and 100A according to the first embodiment and the second embodiment acquire the viewer images of the N number of viewers, and generate and output again the preview screens SC9 and SC10 on which the viewer images of the N number of viewers are grouped into two or more groups based on the changed setting information related the grouping method. Accordingly, the online video distribution support systems 100 and 100A according to the first embodiment and the second embodiment can visualize information related to whether the changed setting information related to the grouping method is a grouping method desired by the distributor TC on the preview screens SC9 and SC10 generated based on a grouping result, and present the information to the distributor TC. Therefore, the distributor TC can efficiently confirm whether the set setting information related to the grouping method includes setting contents desired by the distributor TC based on the preview screens SC9 and SC10.

As described above, the online video distribution support systems 100 and 100A according to the first embodiment and the second embodiment generate and output main venue information (an example of a distribution venue) of an online video in which the distributor TC participates, when it is determined that the distributor TC ungroups at least one group. Accordingly, the online video distribution support systems 100 and 100A according to the first embodiment and the second embodiment can move a group that was ungrouped from a sub venue to a main venue.

As described above, in the online video distribution support systems 100 and 100A according to the first embodiment and the second embodiment, the parameter or the index value is an interest level of a viewer calculated based on the viewer information and the biological information of the distributor TC. As a result, the online video distribution support systems 100 and 100A according to the first embodiment and the second embodiment can group viewers based on interest levels of the viewers.

As described above, the server S1 according to the first embodiment includes one or more computers (for example, the server S1), and includes the communication unit 30 (an example of an acquisition unit) that acquires viewer information related to N (N is an integer equal to or larger than 2) viewers who view an online video, the memory 32 (an example of a storage unit) that stores a grouping condition that is set by the distributor TC who distributes the online video and is used for grouping the N number of viewers into two or more groups, the comparison unit 31B (an example of a calculation unit) that calculates an index value (an example of an index) indicating a viewing situation of each viewer in the online video distribution based on the viewer information acquired by the comparison unit 30, and the processing unit 31A (an example of an output unit) that groups the N number of viewers into two or more groups based on the grouping condition and an index value and outputs the grouping information.

Accordingly, the server S1 according to the first embodiment can group the N number of viewers into two or more groups based on states (parameters or index values) of the viewers. Therefore, even when the distributor TC does not know a state of each of the N number of viewers (for example, an interest level, an understanding level, a sympathy level, or the like), the distributor TC can more efficiently group the N number of viewers by setting the setting information related to the grouping method.

Although various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in various embodiments described above may be combined freely in a range without deviating from the spirit of the invention.

The present disclosure is useful as an online video distribution support method and an online video distribution support apparatus that efficiently calculate a state of a viewer who views a live video online and efficiently support a distributor to select a questioner.

What is claimed is:

1. An online video distribution support method executed by an online video distribution support system including one or more computers that are communicably connected to a plurality of viewer terminals used by an N number of viewers (N is an integer equal to or larger than 2) who view an online video, the online video distribution support method comprising:
acquiring viewer information related to the viewers during distribution of the online video;
calculating an index indicating a viewing situation of the viewers during the distribution of the online video based on the acquired viewer information; and
selecting an M number of viewers (M is an integer satisfying 1≤M<N) from the N number of viewers based on the calculated index, and outputting information related to the selected M number of viewers.

2. The online video distribution support method according to claim 1, further comprising:
generating a screen including images of the selected M number of viewers and outputting the screen.

3. The online video distribution support method according to claim 2, further comprising:
determining a display order of the images of the M number of viewers based on the index; and
generating a screen on which the images of the M number of viewers are rearranged based on the determined display order and outputting the screen.

4. The online video distribution support method according to claim 2, further comprising:
generating a screen on which a frame line is superimposed on an image of a viewer selected among the M number of viewers by a distributor who distributes the online video, and outputting the screen.

5. The online video distribution support method according to claim 2, further comprising:
generating a screen on which an image of a viewer selected among the M number of viewers by a distributor who distributes the online video is displayed in a size larger than a size of an image of a viewer who is not selected by the distributor, and outputting the screen.

6. The online video distribution support method according to claim 2, further comprising:
acquiring utterance voice data of the viewers; and
generating a screen on which a frame line is superimposed on an image of a viewer determined to be a viewer who is uttering among the images of an M number of questioner candidates based on the utterance voice data, and outputting the screen.

7. The online video distribution support method according to claim 2, further comprising:
acquiring utterance voice data of the viewers; and
generating, based on the utterance voice data, a screen on which an image of a viewer determined to be a viewer who is uttering among the images of an M number of questioner candidates is displayed in a size larger than a size of an image of a viewer who is not selected by the distributor, and outputting the screen.

8. The online video distribution support method according to claim 2,
wherein the screen includes a switching button configured to switch the images of the M number of viewers,
the online video distribution support method, further comprising:
selecting a K number of viewers (K: 1≤K≤M) from the M number of viewers that are not included in the screen based on the index in a case that it is determined that the switching button is pressed by the distributor who distributes the online video; and
generating a screen including images of the selected K number of viewers, and outputting the screen.

9. The online video distribution support method according to claim 8, further comprising:
resetting an index of each of the M number of viewers and selecting the K number of viewers based on the reset index of each of the M number of viewers in a case that it is determined that the switching button is pressed by the distributor.

10. The online video distribution support method according to claim 1,
wherein the index is an interest level of the viewers calculated using the viewer information and biological information of a distributor who distributes the online video.

11. The online video distribution support method according to claim 1, further comprising:
distributing a question related to distribution contents of the online video;
acquiring an answer of a viewer to the distributed question;
calculating an understanding level of each of the N number of viewers based on correctness of the answer; and
calculating the index based on the calculated understanding level.

12. An online video distribution support apparatus including one or more computers, the online video distribution support apparatus comprising:
an acquisition unit configured to acquire viewer information related to an N number of viewers (N is an integer equal to or larger than 2) who view an online video;
a calculation unit configured to calculate an index indicating a viewing situation of the viewers during distribution of the online video based on the viewer information; and
an output unit configured to select an M number of viewer (M is an integer satisfying 1≤M<N) from the N number of viewers based on the index calculated by the calculation unit.
